(19) United States
(12) Patent Application Publication
(10) Pub. No.: US 2019/0118387 A1
(43) Pub. Date: Apr. 25, 2019

(54) PARKING DEVICE AND START ASSIST DEVICE

(71) Applicant: YAMAHA HATSUDOKI KABUSHIKI KAISHA, Iwata-shi (JP)

(72) Inventors: Hiroyuki MORITA, Shizuoka (JP); Satoshi KASAI, Shizuoka (JP); Hirokatsu MURAMATSU, Shizuoka (JP); Tatsuro KATAKURA, Shizuoka (JP); Nobuo HARA, Shizuoka (JP)

(21) Appl. No.: 16/162,788

(22) Filed: Oct. 17, 2018

(30) Foreign Application Priority Data
Oct. 20, 2017 (JP) 2017-203518

(51) Int. Cl. B25J 13/08; B25J 9/16; E04H 6/42; B62H 3/02

(52) U.S. Cl. CPC B25J 13/089; B25J 9/1682; B62H 3/02; E04H 6/424; B25J 13/084

(57) ABSTRACT

A parking device that parks a vehicle without use of a mechanism that enables the vehicle to stand by itself, includes an arm that supports the vehicle, an actuator that moves a position of the arm, and a controller configured or programmed to control an operation of the actuator to bring the arm adjacent to the vehicle in accordance with entry of the vehicle into the parking device.

### CROSS REFERENCE TO RELATED APPLICATIONS

This application claims the benefit of priority to Japanese Patent Application No. 2017-203518 filed on Oct. 20, 2017. The entire contents of this application are hereby incorporated herein by reference.

### BACKGROUND OF THE INVENTION

### 1. Field of the Invention

The present invention relates to a parking device that parks a straddled vehicle, and to a start assist device that assists starting the straddled vehicle.

### 2. Description of the Related Art

In recent years, there has been proposed a self-driving technology of allowing a vehicle to drive itself without necessity of driving by an occupant. Moreover, there has been proposed a technology of installing a robot configured to imitate a motion of the human on an existing vehicle and allowing the robot to drive the vehicle.

In International Patent Publication WO 2017/070426, there is disclosed such a technology of installing a robot configured to imitate a motion of the human on a two-wheeled vehicle having an internal combustion engine as a drive source, and allowing the robot to drive the two-wheeled vehicle. The robot installed on the two-wheeled vehicle carries out drive operations such as a steering operation, an accelerator operation, a brake operation, and a gear shift operation so that the two-wheeled vehicle can travel.

When a vehicle such as a two-wheeled vehicle that does not stand by itself in a stopping state is to be parked, the vehicle is allowed to stand by itself through use of, for example, a side stand, a center stand, or an outrigger.

Meanwhile, it is desired that a vehicle be parked without falling down even when the vehicle does not have a mechanism configured to allow the vehicle to stand by itself, such as the stand or the outrigger. For example, it is desired that the self-driving two-wheeled vehicle as described above be parked without use of the mechanism configured to allow the vehicle to stand by itself, such as the stand or the outrigger.

### SUMMARY OF THE INVENTION

Preferred embodiments of the present invention provide parking devices that park vehicles without use of a mechanism that enables the vehicle to stand by itself, such as the stand or the outrigger. Moreover, preferred embodiments of the present invention provide start assist devices that assist starting a straddled vehicle.

According to one preferred embodiment of the present invention, a parking device that parks a straddled vehicle includes an arm that supports the vehicle; an actuator that moves a position of the arm; and a controller configured or programmed to control an operation of the actuator. The controller is configured or programmed to control the actuator to bring the arm adjacent to the vehicle in accordance with entry of the vehicle into the parking device.

In at least one preferred embodiment of the present invention, the parking device may further include a speed sensor that detects a travel speed of the vehicle entering the parking device. The controller may be configured or programmed to change a timing of starting a movement of the arm in accordance with the detected travel speed of the vehicle.

In at least one preferred embodiment of the present invention, when the detected speed of the vehicle is lower than a predetermined speed, the controller may be configured or programmed to delay the timing of starting the movement of the arm compared with a case in which the detected speed is equal to or higher than the predetermined speed.

In at least one preferred embodiment of the present invention, the parking device may further include a speed sensor, which is to be used for detection of a travel speed of the vehicle entering the parking device. The controller may be configured or programmed to change a movement speed of the arm in accordance with the detected travel speed of the vehicle.

In at least one preferred embodiment of the present invention, when the detected speed of the vehicle is lower than a predetermined speed, the controller may be configured or programmed to reduce the movement speed of the arm compared with the case in which the detected speed is equal to or higher than the predetermined speed.

In at least one preferred embodiment of the present invention, the parking device may further include a contact sensor that detects whether or not the arm is in contact with the vehicle. When the contact of the arm with the vehicle is detected, the controller may be configured or programmed to stop the movement of the arm.

In at least one preferred embodiment of the present invention, the parking device may further include a distance sensor that detects a distance between the arm and the vehicle. When the distance between the arm and the vehicle falls below a predetermined value, the controller may be configured or programmed to reduce the movement speed of the arm.

In at least one preferred embodiment of the present invention, in the parking device, the arm may include a first arm and a second arm, the actuator may include a first actuator that moves the first arm, and a second actuator that moves the second arm, and the controller may be configured or programmed to control the first actuator to bring the first arm adjacent to the vehicle from a left side of the vehicle, and control the second actuator to bring the second arm adjacent to the vehicle from a right side of the vehicle.

In at least one preferred embodiment of the present invention, the parking device may further include a position sensor that detects an entry position of the vehicle into the parking device. The controller may be configured or programmed to set at least one of a movement speed and a timing of starting a movement for each of the first arm and the second arm in accordance with the detected entry position of the vehicle.

In at least one preferred embodiment of the present invention, when the detected entry position of the vehicle is closer to a left side of the parking device than a right side of the parking device, the controller may be configured or programmed to perform on of setting of the movement speed of the first arm to a speed lower than the movement speed of the second arm, and delaying of the timing of starting the movement of the first arm compared with the timing of starting the movement of the second arm.

In at least one preferred embodiment of the present invention, the controller may be configured or programmed to calculate a distance between the first arm and the second arm based on operation amounts of the first actuator and the second actuator, and stop the movements of the first arm and the second arm when the distance between the first arm and the second arm falls below a predetermined value.

According to one preferred embodiment of the present invention, a start assist device includes a first rail that carries a first spool of a straddled vehicle; a second rail that carries a second spool of the straddled vehicle; a first jack that supports the first rail; and a second jack that supports the second rail. The first jack adjusts a height of the first rail, and the second jack adjusts a height of the second rail.

In at least one preferred embodiment of the present invention, a lengthwise direction of the first rail and a lengthwise direction of the second rail may be parallel or substantially parallel to one another, and the straddled vehicle may be movable along the lengthwise directions of the first rail and the second rail.

In at least one preferred embodiment of the present invention, the first rail may include a recess to which the first spool is fitted, and the second rail may include a recess to which the second spool is fitted. In at least one preferred embodiment of the present invention, at least a portion of the first rail may have a tapered shape, and at least a portion of the second rail may have a tapered shape.

The parking device according to one preferred embodiment of the present invention brings the arm that supports the straddled vehicle adjacent to the vehicle in accordance with the entry of the vehicle into the parking device. The straddled vehicle is supported by the arm, and maintains the stop state in the upright posture without falling down. As a result, the vehicle is parked without use of a mechanism that enables the vehicle to stand by itself, such as the side stand, the center stand, or the outrigger.

The above and other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a top view for illustrating a parking device according to a preferred embodiment of the present invention.

FIG. 2 is a rear view for illustrating the parking device according to a preferred embodiment of the present invention.

FIG. 3 is a view for illustrating movements of arms according to a preferred embodiment of the present invention.

FIG. 4 is a view for illustrating movements of the arms according to a preferred embodiment of the present invention.

FIG. 5 is a view for illustrating movements of the arms according to a preferred embodiment of the present invention.

FIG. 6 is a view for illustrating the arms according to a preferred embodiment of the present invention.

FIG. 7 is a diagram for illustrating a controller of the parking device according to a preferred embodiment of the present invention.

FIG. 8 is a flowchart for illustrating a process of controlling operations of actuators according to a preferred embodiment of the present invention.

FIG. 9 is a flowchart for illustrating a process of controlling the actuators according to a preferred embodiment of the present invention.

FIG. 10 includes portions (a) to (l) that are timing charts for illustrating the control of the actuators according to a preferred embodiment of the present invention.

FIG. 11 is a view for illustrating movements of the arms in accordance with entry of the vehicle into the parking device according to a preferred embodiment of the present invention.

FIG. 12 is a view for illustrating movements of the arms in accordance with the entry of the vehicle into the parking device according to a preferred embodiment of the present invention.

FIG. 13 is a view for illustrating movements of the arms in accordance with the entry of the vehicle into the parking device according to a preferred embodiment of the present invention.

FIG. 14 is a view for illustrating movements of the arms in accordance with the entry of the vehicle into the parking device according to a preferred embodiment of the present invention.

FIG. 15 is a view for illustrating movements of the arms in accordance with the entry of the vehicle into the parking device according to a preferred embodiment of the present invention.

FIG. 16 includes portions (a) to (l) that are timing charts for illustrating another example of the control of the actuators according to a preferred embodiment of the present invention.

FIG. 17 is a perspective view for illustrating the parking device including robot arms according to a preferred embodiment of the present invention.

FIG. 18 is a perspective view for illustrating the parking device including the robot arms according to a preferred embodiment of the present invention.

FIG. 19 is a top view for illustrating the parking device including the robot arms according to a preferred embodiment of the present invention.

FIG. 20 is a rear view for illustrating the parking device including the robot arms according to a preferred embodiment of the present invention.

FIG. 21 is a perspective view for illustrating a start assist device according to a preferred embodiment of the present invention.

FIG. 22 is a side view for illustrating a rear portion of a straddled vehicle according to a preferred embodiment of the present invention.

FIG. 23 is a view for illustrating spools provided on the straddled vehicle according to a preferred embodiment of the present invention.

FIG. 24 is a view for illustrating the straddled vehicle parked through use of the start assist device according to a preferred embodiment of the present invention.

FIG. 25 is a view for illustrating a jig used for operation of jacks of the start assist device according to a preferred embodiment of the present invention.

FIG. 26 is a view for illustrating the straddled vehicle starting and moving forward from the start assist device according to a preferred embodiment of the present invention.

### DETAILED DESCRIPTION OF THE PREFERRED EMBODIMENTS

Now, description is provided of preferred embodiments of the present invention with reference to the drawings. The same components are denoted by the same reference symbols, and redundant description thereof is omitted. The present invention is not limited to the following preferred embodiments.

### First Preferred Embodiment

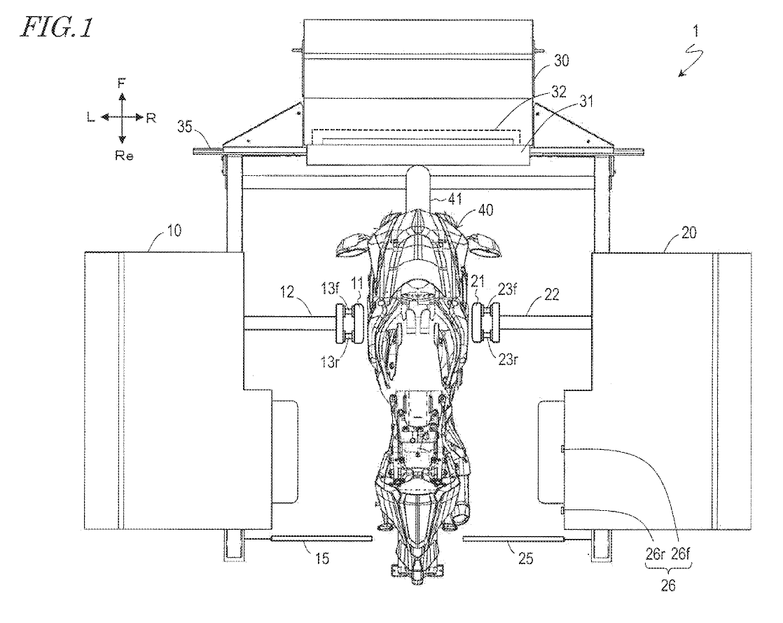

FIG. 1 is a top view for illustrating a parking device 1 according to a preferred embodiment of the present invention. The parking device 1 is a device that parks a straddled vehicle 40.

In an example illustrated in FIG. 1, the straddled vehicle 40 is preferably a two-wheeled motor vehicle of an on-road type, for example. However, the straddled vehicle 40 in the present preferred embodiment of the present invention is not limited to the two-wheeled motor vehicle of the on-road type exemplified herein. The straddled vehicle in the present preferred embodiment of the present invention may be a two-wheeled motor vehicle of another type such as a scooter type, an off-road type, and a moped type. A drive source that drives the straddled vehicle may be an internal combustion engine, an electric motor, or a hybrid system constructed through combination of an internal combustion engine and an electric motor. Moreover, the straddled vehicle in the present preferred embodiment of the present invention corresponds to a suitably-selected vehicle on which an occupant rides in a straddling manner, and is not limited to a two-wheeled vehicle. The straddled vehicle 40 may be, for example, a three-wheeled vehicle whose travel direction is changed by leaning a vehicle body. Moreover, the straddled vehicle 40 may be a bicycle. The straddled vehicle 40 is, for example, a vehicle that does not stand by itself when the vehicle stops.

In the following description, unless otherwise specified, front, rear, left, right, up, and down correspond to front, rear, left, right, up, and down, respectively, as viewed from an occupant seating on a seat of the two-wheeled motor vehicle 40 being parked in the parking device 1. Up and down correspond to up and down in a vertical direction when the two-wheeled motor vehicle 40 stands upright on a horizontal plane. Reference symbols F, Re, L, R, U, and D in the drawings represent front, rear, left, right, up, and down, respectively.

The parking device 1 illustrated in FIG. 1 includes a left base 10, a right base 20, and a front base 30. The left base 10 is located on a left side of the parking device 1. The right base 20 is located on a right side of the parking device 1. The front base 30 is located on a front side of the parking device 1.

An arm 12 which is movable in a right-and-left direction with respect to the left base 10 is provided in the left base 10. An arm 22 which is movable in the right-and-left direction with respect to the right base 20 is provided in the right base 20. The arms 12 and 22 support the two-wheeled motor vehicle 40 during parking.

The front base 30 includes a wall 31 that is opposed to the two-wheeled motor vehicle 40 positioned in the parking device 1. The front base 30 includes a damper 32 that supports the wall 31. The damper 32 is extendable and retractable in a front-and-rear direction. With this structure, the wall 31 is movable in the front-and-rear direction. With the damper 32 provided on the parking device 1, even when a front wheel 41 of the two-wheeled motor vehicle 40 having entered the parking device 1 comes in contact with the wall 31, impact of the contact is reduced. The front base 30 is movable in a right-and-left direction along a rail 35. When the two-wheeled motor vehicle 40 starts, the two-wheeled motor vehicle 40 moves forward after the front base 30 is moved rightward or leftward.

The arm 12 includes a contact member 11 and dampers 13f and 13r at a right end portion. The arm 22 includes a contact member 21 and dampers 23f and 23r at a left end portion. When the two-wheeled motor vehicle 40 is being parked, the contact member 11 of the arm 12 or the contact member 21 of the arm 22 is in contact with the two-wheeled motor vehicle 40. The contact members 11 and 21 are made of an elastic material such as rubber. The contact members 11 and 21 have elasticity, and thus define cushions that alleviate impact when the arms 12 and 22 come in contact with the two-wheeled motor vehicle 40. Moreover, end portions of the contact members 11 and 21 each have a round shape. With this structure, the contact members 11 and 21 are prevented from being caught on the body of the two-wheeled motor vehicle 40.

The dampers 13f and 13r of the arm 12 are extendable and retractable independently of one another. Moreover, the dampers 23f and 23r of the arm 22 are extendable and retractable independently of one another. With this structure, even when the two-wheeled motor vehicle 40 enters and stops obliquely with respect to the front-and-rear direction, the contact members 11 and 21 support the two-wheeled motor vehicle 40 in a state in which the contact members 11 and 21 are oriented in directions following a body shape of the two-wheeled motor vehicle 40.

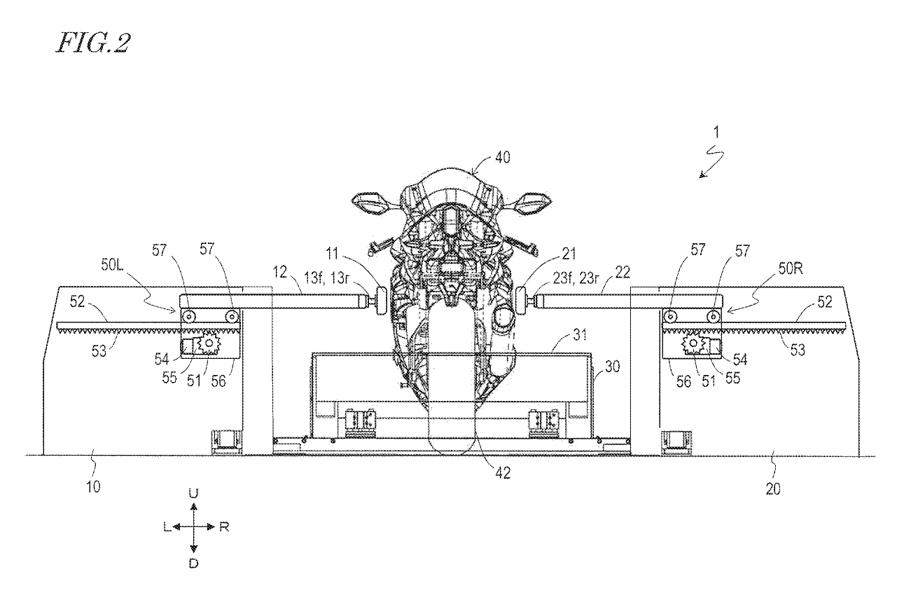

FIG. 2 is a rear view for illustrating the parking device 1 as viewed from a rear side. For ease of understanding, insides of the left base 10 and the right base 20 are transparently illustrated. Moreover, the two-wheeled motor vehicle 40 is transparently illustrated.

The left base 10 includes an actuator 50L that moves the arm 12. The right base 20 includes an actuator 50R that moves the arm 22. The actuators 50L and 50R are, for example, linear actuators that move the arms 12 and 22, respectively, in the right-and-left direction. The specific mechanism of each of the actuators 50L and 50R is suitably selected. The actuators 50L and 50R illustrated in FIG. 2 each include a rack and pinion mechanism as an example of the mechanism.

In the example illustrated in FIG. 2, the actuator 50L includes a pinion gear 51, a rail 52, an electric motor 54, a speed reducer 55, a housing 56, and wheels 57. The pinion gear 51, the electric motor 54, the speed reducer 55, and the wheels 57 are provided in the housing 56. The rail 52 including a rack gear 53 is fixed to the left base 10. The wheels 57 roll along the rail 52. The arm 12 is mounted to the housing 56.

Rotation of the electric motor 54 is reduced in speed by the speed reducer 55, and is then transmitted to the pinion gear 51. The housing 56 moves in the right-and-left direction through rotation of the pinion gear 51 meshing with the rack gear 53. With this structure, the arm 12 is moved in the right-and-left direction.

Similarly to the actuator 50L, the actuator 50R includes a pinion gear 51, a rail 52, an electric motor 54, a speed reducer 55, a housing 56, and wheels 57. The rail 52 including a rack gear 53 is fixed to the right base 20. The arm 22 is mounted to the housing 56. The housing 56 moves in the right-and-left direction through rotation of the pinion gear 51 meshing with the rack gear 53. With this structure, the arm 22 is moved in the right-and-left direction.

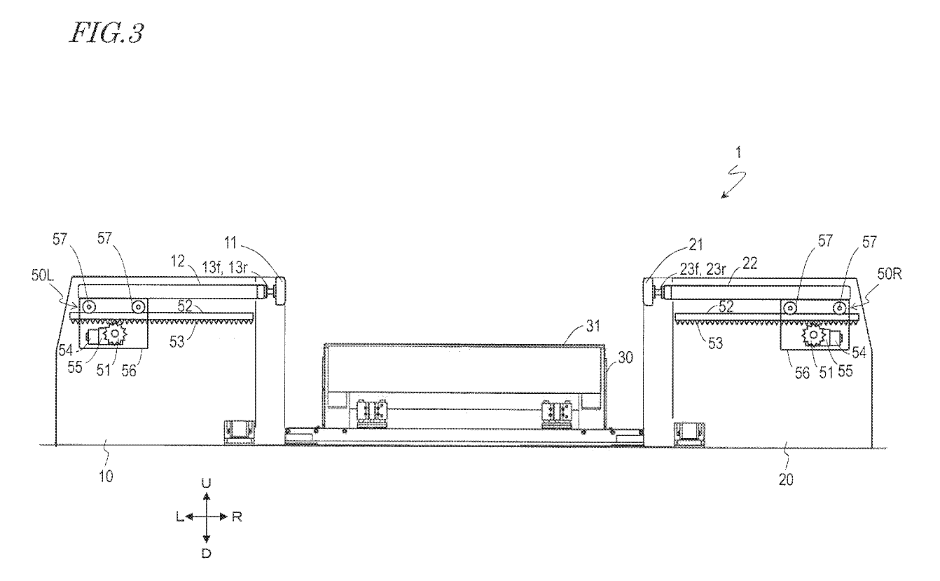

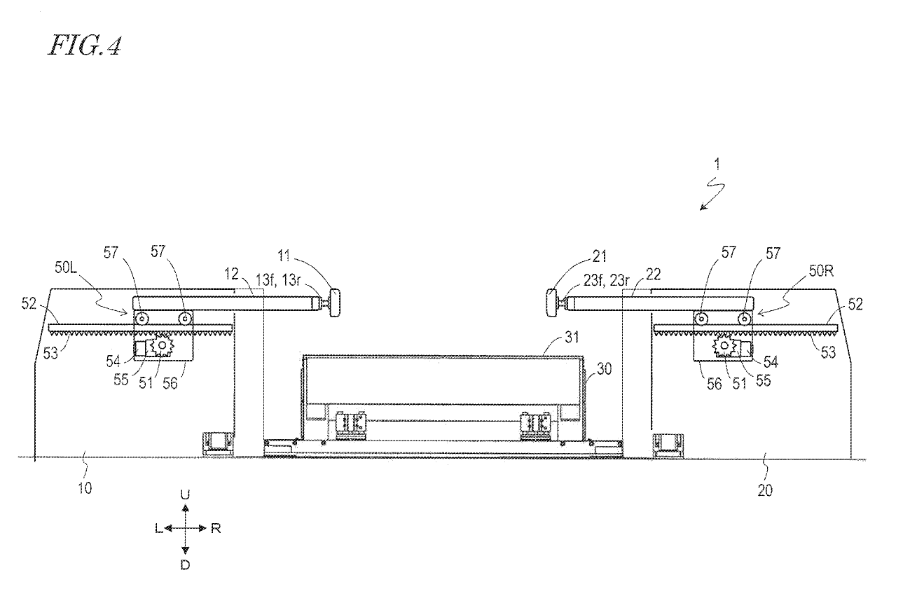

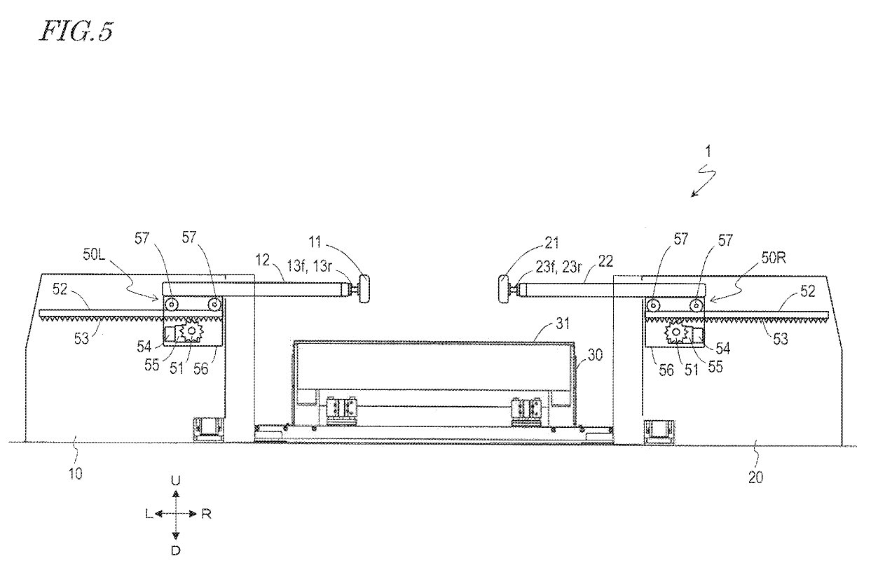

FIG. 3, FIG. 4, and FIG. 5 are views for illustrating movements of the arms 12 and 22. When the two-wheeled motor vehicle 40 is not positioned in the parking device 1, as illustrated in FIG. 3, the arm 12 is positioned on the left side spaced apart from a center of the parking device 1 in the right-and-left direction. The arm 22 is positioned on the right side spaced apart from the center of the parking device 1 in the right-and-left direction. When the two-wheeled motor vehicle 40 enters the parking device 1, as illustrated in FIG. 4 and FIG. 5, the actuators 50L and 50R operate to move the arm 12 rightward and the arm 22 leftward. The arms 12 and 22 having approached the two-wheeled motor vehicle 40 in the parking device 1 stop before coming in contact with the two-wheeled motor vehicle 40. For example, the arms 12 and 22 stop in a state in which a distance between each of the contact members 11 and 21 and the two-wheeled motor vehicle 40 is several centimeters (such as about three centimeters). The two-wheeled motor vehicle 40 having stopped in the parking device 1 tilts rightward or leftward, and thus comes in contact with and is supported by any one of the contact members 11 and 21.

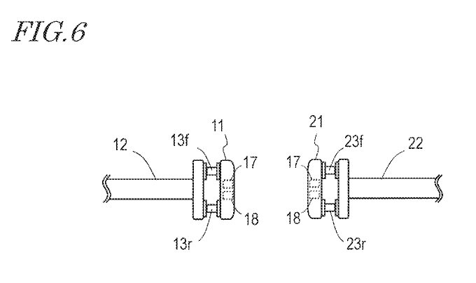

FIG. 6 is a view for illustrating the arms 12 and 22. Each of the arms 12 and 22 includes a distance sensor 17 and a contact sensor 18. The distance sensor 17 of the arm 12 detects a distance between the arm 12 and the two-wheeled motor vehicle 40. The contact sensor 18 of the arm 12 detects whether or not the arm 12 is in contact with the two-wheeled motor vehicle 40. The distance sensor 17 of the arm 22 detects a distance between the arm 22 and the two-wheeled motor vehicle 40. The contact sensor 18 of the arm 22 detects whether or not the arm 22 is in contact with the two-wheeled motor vehicle 40. The type of the distance sensor 17 is suitably selected, and a distance sensor that uses, for example, a light emitting diode or a laser light emitting device may be used. The type of the contact sensor 18 is suitably selected, and, for example, a displacement sensor, a pressure sensor, and a switch device that mechanically switches between on/off states through depression may be used. In the example illustrated in FIG. 6, the distance sensor 17 and the contact sensor 18 are provided in each of the contact members 11 and 21.

The arms 12 and 22 include the distance sensors 17, and thus the arms 12 and 22 are stopped in a state in which a suitable gap is defined between each of the contact members 11 and 21 and the two-wheeled motor vehicle 40. Moreover, the arms 12 and 22 include the contact sensors 18, and thus the contact of the arms 12 and 22 with the two-wheeled motor vehicle 40 are detected. When any one of the arms 12 and 22 comes in contact with the two-wheeled motor vehicle 40 traveling in the parking device 1, disturbance of a posture of the two-wheeled motor vehicle 40 is reduced by immediately stopping the arm that has come in contact with the two-wheeled motor vehicle 40.

The actuators 50L and 50R may include locks that lock the motions of the mechanisms so as to more reliably support the two-wheeled motor vehicle 40. For example, the actuators 50L and 50R may include electromagnetic brakes as the locks. Moreover, worm gears may be provided on the speed reducers 55 to prevent movements of the arms 12 and 22 caused by the load from the vehicle.

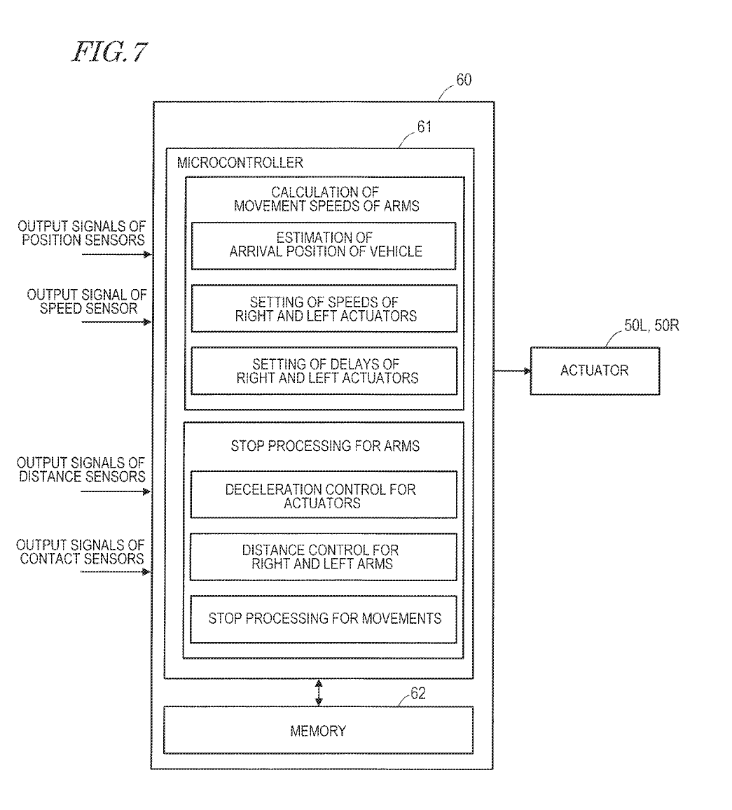

FIG. 7 is a diagram for illustrating a controller 60 of the parking device 1. The controller 60 is provided on, for example, at least one of the left base 10 and the right base 20. The controller 60 is configured or programmed to control the operation of the parking device 1. The controller 60 includes a microcontroller 61 and a memory 62. The memory 62 stores a computer program that executes a procedure of controlling operations of respective elements of the parking device 1. The microcontroller 61 reads the computer program from the memory 62 to carry out various types of control. A driver circuit that drives the actuators 50L and 50R may be provided in the controller 60, or in each of the actuators 50L and 50R. Moreover, the microcontroller 61 and the memory 62 may be provided in each of the actuators 50L and 50R.

Output signals of various sensors are input to the controller 60. Referring to FIG. 1, the parking device 1 includes a speed sensor 26 that detects a travel speed of the two-wheeled motor vehicle 40 entering the parking device 1. In the example illustrated in FIG. 1, the speed sensor 26 includes phototube switches 26f and 26r. The type of the speed sensor 26 is suitably selected, and, for example, a sensor of a type that uses millimeter wave radar or ultrasonic sonar may be used. Moreover, a camera may be used as the speed sensor 26, and the speed may be determined based on a change in taken images of the two-wheeled motor vehicle 40.

In the example illustrated in FIG. 1, the phototube switches 26f and 26r are provided on the rear side of the right base 20. The phototube switch 26f is provided in front of the phototube switch 26r. A distance between the phototube switch 26f and the phototube switch 26r in the front-and-rear direction is defined in advance. The two-wheeled motor vehicle 40 enters the parking device 1 from the rear side of the parking device 1. The controller 60 measures a time period from a time point at which the traveling two-wheeled motor vehicle 40 reaches a position of the phototube switch 26r to a time point at which the two-wheeled motor vehicle 40 reaches a position of the phototube switch 26f, so as to calculate the travel speed of the two-wheeled motor vehicle 40. Moreover, when three or more phototube switches are located along the front-and-rear direction, the acceleration (deceleration) of the two-wheeled motor vehicle 40 is able to be calculated.

Referring to FIG. 1, the parking device 1 includes position sensors 15 and 25 that detect an entry position of the two-wheeled motor vehicle 40 entering the parking device 1 in the right-and-left direction. In the example illustrated in FIG. 1, the position sensors 15 and 25 are tape switches, for example. The type of the position sensor is suitably selected, and a position sensor that uses, for example, a light emitting diode or a laser light emitting device may be used. Moreover, a camera may be used as the position sensor, and the entry position may be determined based on a taken image of the two-wheeled motor vehicle 40.

In the example illustrated in FIG. 1, the tape switches 15 and 25 are provided on the rear side of the parking device 1. The tape switch 15 is positioned on the left side with respect to the center of the parking device 1 in the right-and-left direction. The tape switch 25 is positioned on the right side with respect to the center of the parking device 1 in the right-and-left direction. A gap is defined between the tape switch 15 and the tape switch 25 in the right-and-left direction.

When the two-wheeled motor vehicle 40 enters while being displaced toward the left side with respect to the center of the parking device 1 in the right-and-left direction, the front wheel 41 of the two-wheeled motor vehicle 40 runs over the tape switch 15. When the load is applied to the tape switch 15, the tape switch 15 turns on, and a signal is output to the controller 60. Meanwhile, when the two-wheeled motor vehicle 40 enters while being displaced toward the right side with respect to the center of the parking device 1 in the right-and-left direction, the front wheel 41 of the two-wheeled motor vehicle 40 runs over the tape switch 25. When the load is applied to the tape switch 25, the tape switch 25 turns on, and a signal is output to the controller 60. When the entry position of the two-wheeled motor vehicle 40 is approximately adjacent to the center of the parking device 1 in the right-and-left direction, the front wheel 41 of the two-wheeled motor vehicle 40 does not run over any one of the tape switches 15 and 25, and thus no signal is output from the tape switches 15 and 25. The microcontroller 61 is able to detect the entry position of the two-wheeled motor vehicle 40 in accordance with presence or absence of the signal from the tape switches 15 and 25.

Functional blocks of the microcontroller 61 are illustrated inside the microcontroller 61 of FIG. 7. The microcontroller 61 sets the movement speeds of the arms 12 and 22. The microcontroller 61 estimates a stop position of the two-wheeled motor vehicle 40 in the parking device 1 based on, for example, the entry speed and the entry position of the two-wheeled motor vehicle 40. Timings of starting the operations of the actuators 50L and 50R and the movement speeds of the actuators 50L and 50R are set in accordance with the estimated stop position.

Moreover, the microcontroller 61 performs a control of stopping the arms 12 and 22. When the arms 12 and 22 are brought adjacent to the two-wheeled motor vehicle 40 at a predetermined distance, the microcontroller 61 decelerates the actuators 50L and 50R. The microcontroller 61 calculates a distance between the arm 12 and the arm 22 based on operation amounts of the actuators 50L and 50R. The microcontroller 61 stops the movements of the arm 12 and the arm 22 when the distance between the arm 12 and the arm 22 becomes less than a predetermined value. When the arm 12 or the arm 22 comes in contact with the two-wheeled motor vehicle 40, the microcontroller 61 immediately stops the movement of the arm having come in contact with the two-wheeled motor vehicle 40.

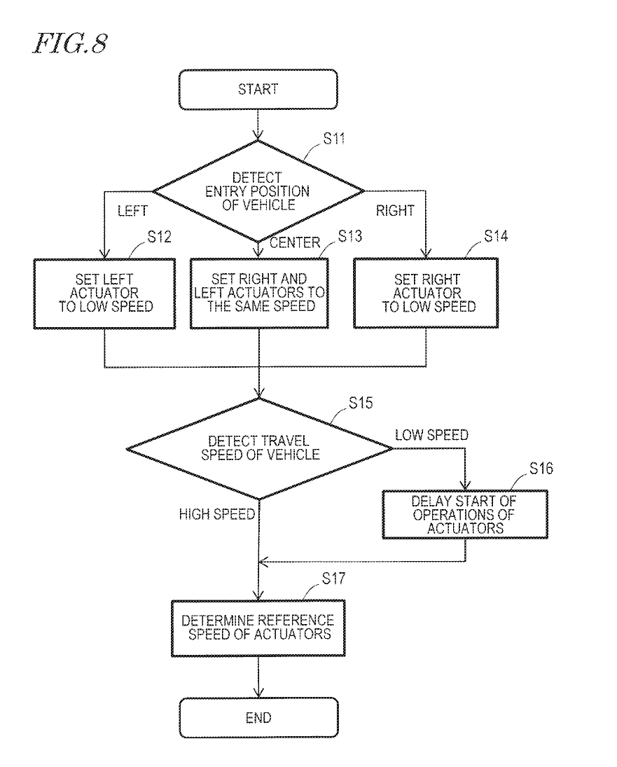

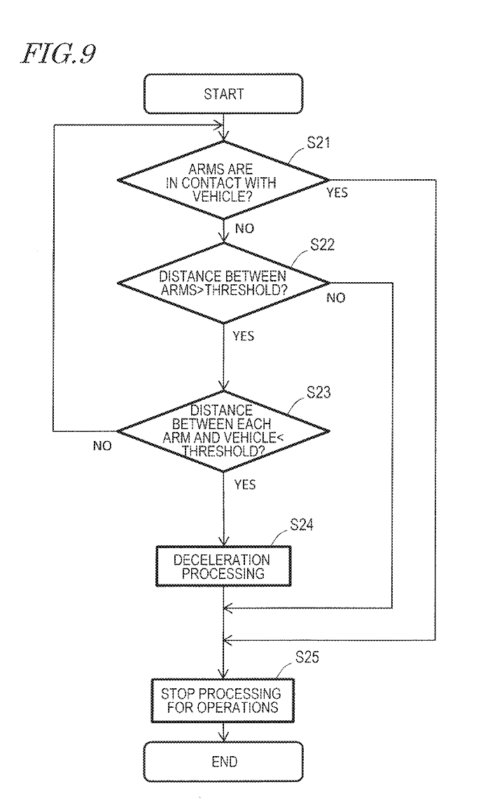

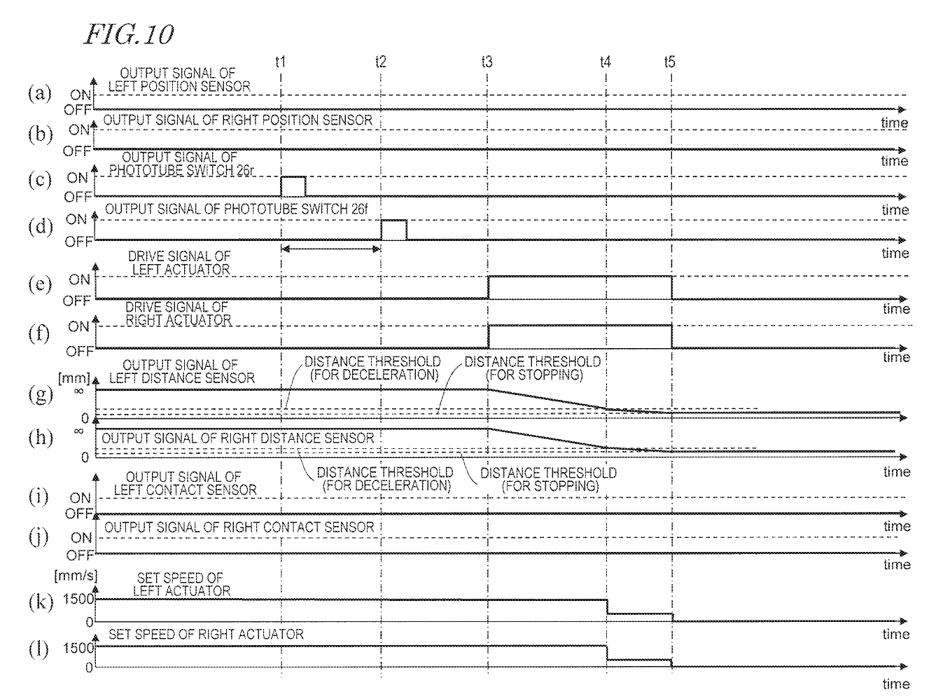

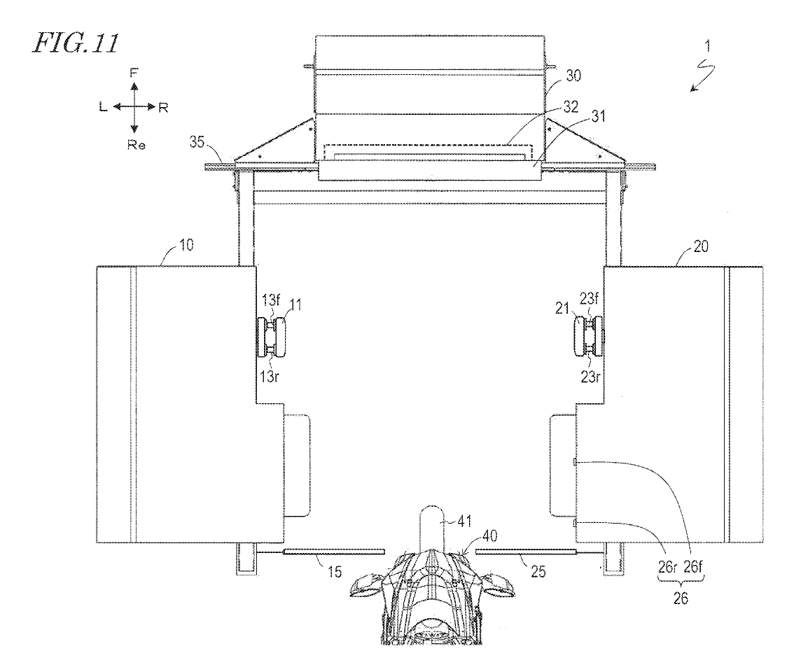

FIG. 8 and FIG. 9 are flowcharts for illustrating a process of controlling the operations of the actuators 50L and 50R. Portions (a) to (l) of FIG. 10 are timing charts for illustrating the control of the actuators 50L and 50R in accordance with output signals of various sensors. FIG. 11 to FIG. 15 are views for illustrating movements of the arms 12 and 22 in accordance with the entry of the two-wheeled motor vehicle 40 into the parking device 1.

Respective horizontal axes of Portions (a) to (l) of FIG. 10 represent time. A vertical axis of portion (a) of FIG. 10 represents an output signal of the position sensor (such as the tape switch 15) arranged on the left side. A vertical axis of portion (b) of FIG. 10 represents an output signal of the position sensor (such as the tape switch 25) arranged on the right side. A vertical axis of portion (c) of FIG. 10 represents an output signal of the phototube switch 26r. A vertical axis of portion (d) of FIG. 10 represents an output signal of the phototube switch 26f. A vertical axis of portion (e) of FIG. 10 represents a drive signal of the actuator 50L. A vertical axis of portion (f) of FIG. 10 represents a drive signal of the actuator 50R. A vertical axis of portion (g) of FIG. 10 represents an output signal of the distance sensor 17 provided on the arm 12. A vertical axis of portion (h) of FIG. 10 represents an output signal of the distance sensor 17 provided on the arm 22. A vertical axis of portion (i) of FIG. 10 represents an output signal of the contact sensor 18 provided on the arm 12. A vertical axis of portion (j) of FIG. 10 represents an output signal of the contact sensor 18 provided on the arm 22. A vertical axis of portion (k) of FIG. 10 represents a set speed of the actuator 50L. A vertical axis of portion (l) of FIG. 10 represents a set speed of the actuator 50R.

FIG. 11 is a view for illustrating a state in which the two-wheeled motor vehicle 40 starts entering the parking device 1. In the example of the process illustrated in FIG. 8, the entry position of the two-wheeled motor vehicle 40 in the right-and-left direction of the parking device 1 is first detected (Step S11). The entry position of the two-wheeled motor vehicle 40 may be detected through use of the tape switches 15 and 25.

When the two-wheeled motor vehicle 40 enters while being displaced toward the left side with respect to the center of the parking device 1 in the right-and-left direction, the microcontroller 61 sets the movement speed of the actuator 50L to a low speed (Step S12). As a result, the contact force between the two-wheeled motor vehicle 40, which travels in the parking device 1 while being displaced toward the left side, and the arm 12 is reduced.

When the two-wheeled motor vehicle 40 enters while being displaced toward the right side with respect to the center of the parking device 1 in the right-and-left direction, the microcontroller 61 sets the movement speed of the actuator 50R to a low speed (Step S14). As a result, the contact force between the two-wheeled motor vehicle 40, which travels in the parking device 1 while being displaced toward the right side, and the arm 22 is reduced.

When the entry position of the two-wheeled motor vehicle 40 is approximately adjacent to the center of the parking device 1 in the right-and-left direction, the tape switches 15 and 25 are not brought into the ON state. In this case, the microcontroller 61 sets the movement speeds of the actuator 50L and 50R to a reference speed (Step S13). A magnitude of the reference speed is larger than that when the low speed is set. In the example illustrated in portions (a) and (b) of FIG. 10, the entry position of the two-wheeled motor vehicle 40 is approximately at the center, and the tape switches 15 and 25 are not in the ON state.

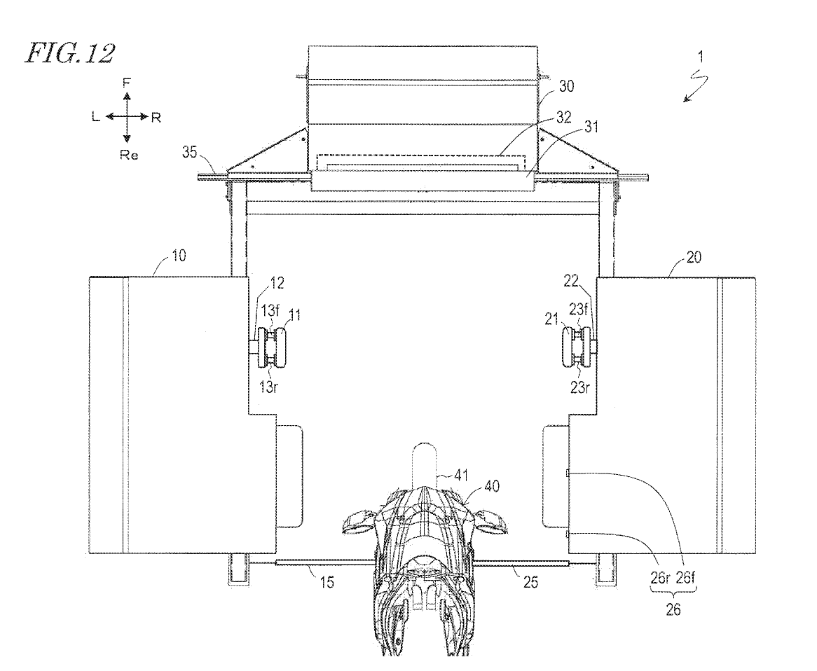

At a time point t1 illustrated in FIG. 10, when the two-wheeled motor vehicle 40 reaches the position of the phototube switch 26r in the front-and-rear direction, the phototube switch 26r turns ON (the output signal becomes Hi). At a time point t2, when the two-wheeled motor vehicle 40 reaches the position of the phototube switch 26f as illustrated in FIG. 12, the phototube switch 26f turns ON (the output signal becomes Hi). The microcontroller 61 calculates the travel speed of the two-wheeled motor vehicle 40 based on the time period from the turning ON of the phototube switch 26r to the turning ON of the phototube switch 26f (Step S15). For example, the two-wheeled motor vehicle 40 enters the parking device 1 at a speed of about 15 km/h. On this occasion, the two-wheeled motor vehicle 40 enters in a state in which, for example, the drive by the internal combustion engine is off, and the shift position of a transmission is at a low gear. Data on a deceleration in such a vehicle state is stored in the memory 62 in advance. The microcontroller 61 estimates a position at which the two-wheeled motor vehicle 40 stops based on the travel speed of the two-wheeled motor vehicle 40 and the data on the deceleration.

When the travel speed of the two-wheeled motor vehicle 40 is equal to or higher than a predetermined speed (when the travel speed is a high speed), the microcontroller 61 starts the movements of the actuators 50L and 50R at a standard timing. The predetermined speed is, for example, about 15 km/h, but is not limited thereto. When the travel speed of the two-wheeled motor vehicle 40 is lower than the predetermined speed (when the travel speed is a low speed), the timings of starting the movements of the actuators 50L and 50R are delayed (Step S16). As a result, the contact force between the two-wheeled motor vehicle 40, which travels in the parking device 1, and the arms 12 and 22 is reduced.

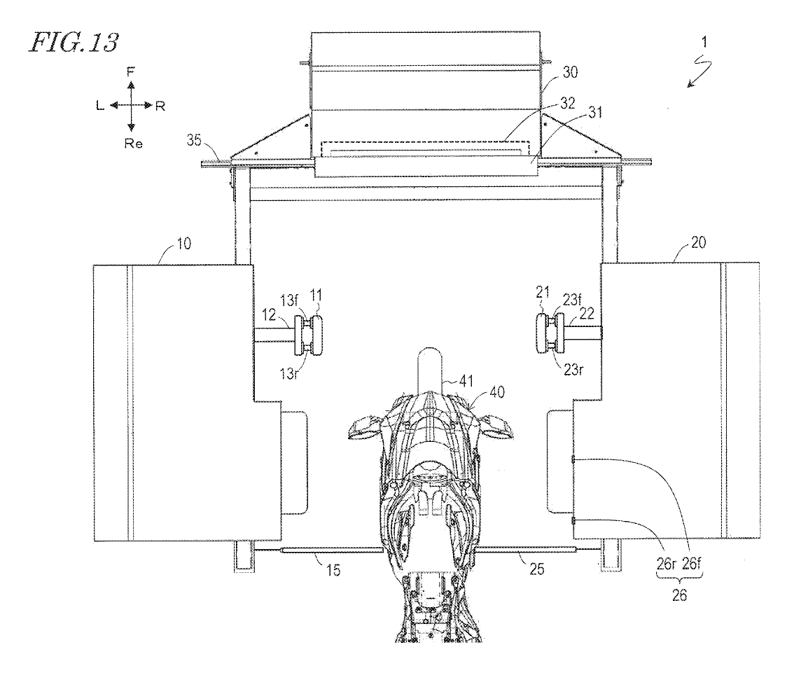

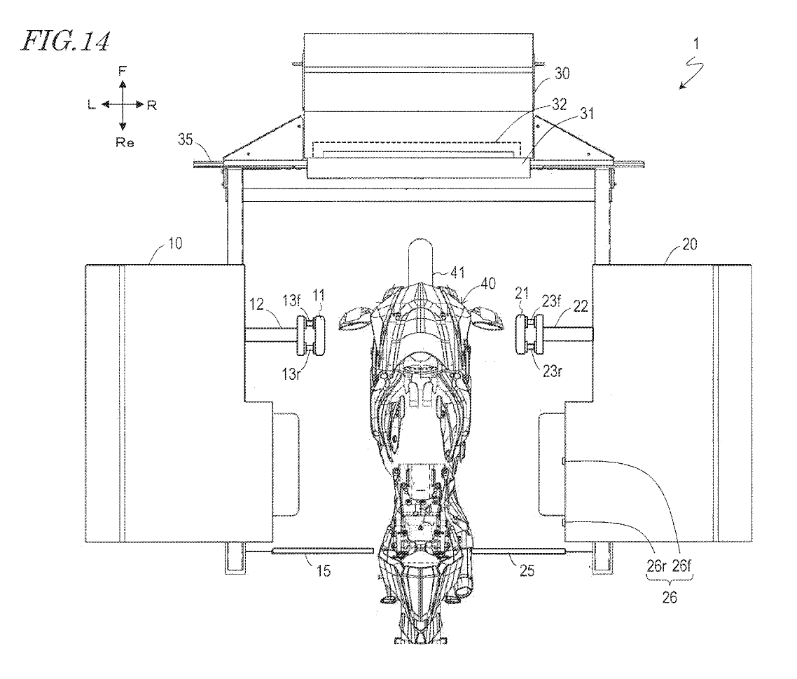

Through the above-described process, the timings of starting the movements of the actuators 50L and 50R and the movement speeds of the actuators 50L and 50R are determined (Step S17). In the example shown in FIG. 10, the actuators 50L and 50R start moving at a time point t3, and the movement speeds are the standard speed. FIG. 13 and FIG. 14 are views for illustrating a state in which the arm 12 is brought adjacent to the two-wheeled motor vehicle 40 from the left side of the two-wheeled motor vehicle 40 and in which the arm 22 is brought adjacent to the two-wheeled motor vehicle 40 from the right side of the two-wheeled motor vehicle 40.

FIG. 9 is a flowchart for illustrating an example of a process of stopping the actuators 50L and 50R. The process illustrated in FIG. 9 may be carried out independently for each of the actuators 50L and 50R. In Step S21, the microcontroller 61 uses the output signals of the contact sensors 18 to determine whether or not the arms 12 and 22 are in contact with the two-wheeled motor vehicle 40. When the contact of at least one of the arms 12 and 22 with the two-wheeled motor vehicle 40 is detected, the microcontroller 61 stops the actuator that moves the arm that has come in contact with the two-wheeled motor vehicle 40 (Step S25). When the arm that has come in contact with the two-wheeled motor vehicle 40 continues to move, a posture of the two-wheeled motor vehicle 40 may be disturbed. When the contact is detected, the disturbance of the posture of the two-wheeled motor vehicle 40 is reduced by stopping the movement of the corresponding arm.

When the contact is not detected, the microcontroller 61 calculates a distance between the arm 12 and the arm 22 based on the operation amounts of the actuators 50L and 50R (Step S22). When the distance between the arm 12 and the arm 22 is less than a predetermined value, the microcontroller 61 stops the actuators 50L and 50R (Step S25). The contact between the two-wheeled motor vehicle 40, which travels in the parking device 1, and the arms 12 and 22 is prevented by preventing the gap between the arm 12 and the arm 22 from becoming excessively small.

When the distance between the arm 12 and the arm 22 is equal to or more than the predetermined value, the microcontroller 61 uses the output signals of the distance sensors 17 to detect the distance between the arm 12 and the two-wheeled motor vehicle 40 and the distance between the arm 22 and the two-wheeled motor vehicle 40 (Step S23).

When the detected distances are equal to or more than a threshold for the deceleration shown in portions (g) and (h) of FIG. 10, the process returns to the process in Step S21. When the detected distance is less than the threshold for the deceleration, deceleration of the actuator that moves the corresponding arm is started (Step S24, time point t4). Then, when the detected distance falls below a threshold for the stopping shown in portions (g) and (h) of FIG. 10, the actuator is stopped (Step S25, time point t5).

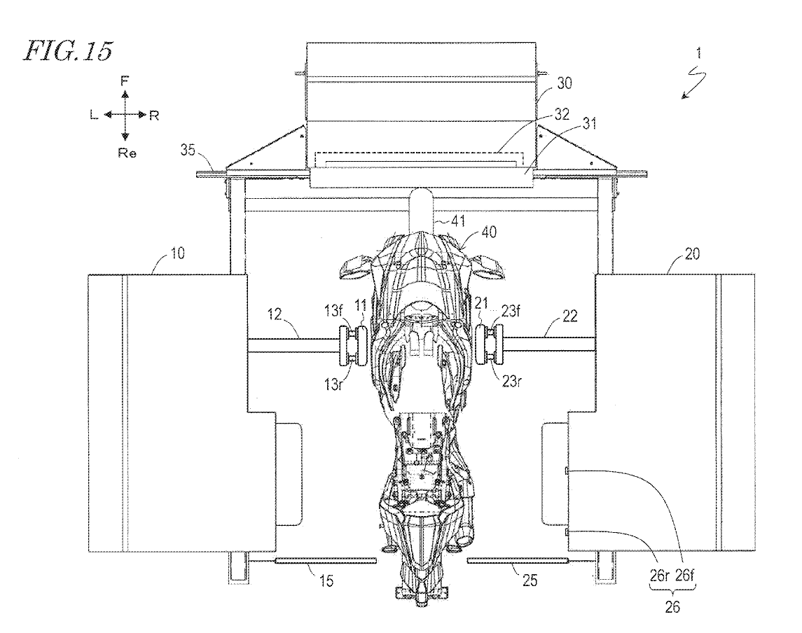

As illustrated in FIG. 15, the microcontroller 61 stops the actuators 50L and 50R before the arms 12 and 22 come in contact with the two-wheeled motor vehicle 40. For example, in a state in which the distances between the respective contact members 11 and 21 and the two-wheeled motor vehicle 40 are several centimeters (such as about three centimeters), the actuators 50L and 50R are stopped. The two-wheeled motor vehicle 40 having stopped in the parking device 1 tilts rightward or leftward, and thus comes in contact with and is supported by any one of the contact members 11 and 21. Regardless of whether the two-wheeled motor vehicle 40 tilts rightward or leftward after stopping, the two-wheeled motor vehicle 40 is supported by the arm 12 or 22, and maintains the stop state in the upright posture without falling down. As a result, the two-wheeled motor vehicle 40 is parked without using a mechanism that enables the two-wheeled motor vehicle 40 to stand by itself, such as a side stand, a center stand, or an outrigger.

In the example illustrated in FIG. 8, although the movement speed of the actuator 50L or 50R is set to the low speed in accordance with the detected entry position of the two-wheeled motor vehicle 40, the timing of starting the movement of the actuator 50L or 50R may be delayed in accordance with the entry position. Moreover, in the example illustrated in FIG. 8, when the detected speed of the two-wheeled motor vehicle 40 is lower than the predetermined speed, the timings of starting the operations of the actuators 50L and 50R are delayed, but the movement speeds of the actuators 50L and 50R may be reduced. As a result, the contact force between the two-wheeled motor vehicle 40, which travels in the parking device 1, and the arms 12 and 22 is reduced.

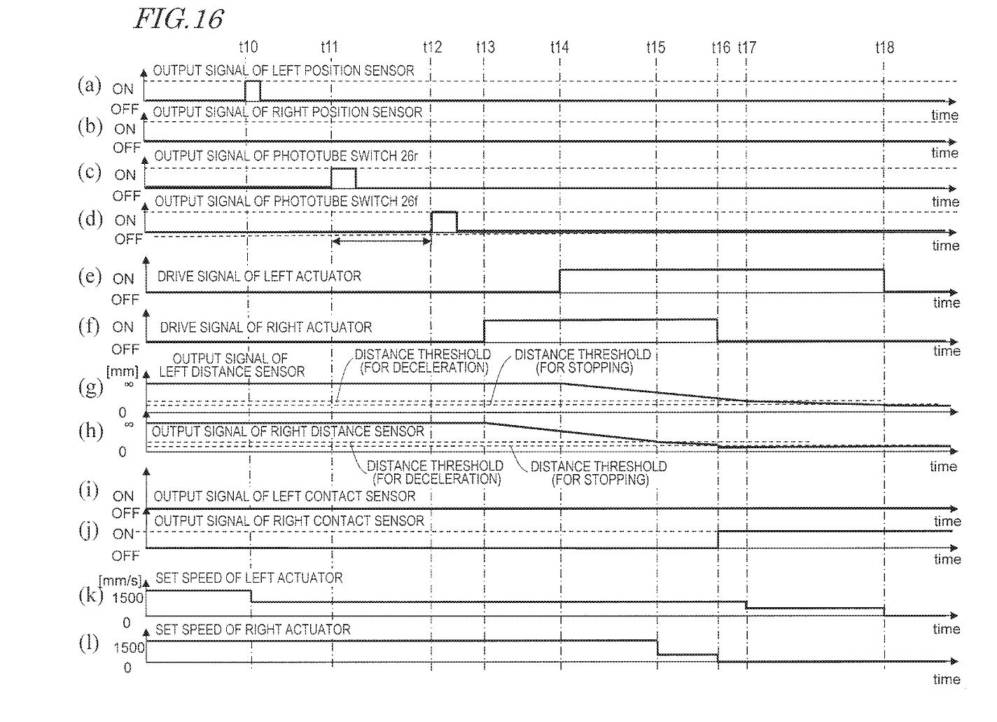

Referring to FIG. 16, description is now provided of another example of the operation of the parking device 1. Portions (a) to (l) of FIG. 16 are timing charts for illustrating the operation example of the parking device 1 when the two-wheeled motor vehicle 40 enters the parking device 1 while being displaced toward the left side in the right-and-left direction, and then rolls rightward.

Respective horizontal axes of portions (a) to (l) of FIG. 16 represent time. A vertical axis of portion (a) of FIG. 16 represents an output signal of the position sensor (such as the tape switch 15) arranged on the left side. A vertical axis of portion (b) of FIG. 16 represents an output signal of the position sensor (such as the tape switch 25) arranged on the right side. A vertical axis of portion (c) of FIG. 16 represents an output signal of the phototube switch 26r. A vertical axis of portion (d) of FIG. 16 represents an output signal of the phototube switch 26f. A vertical axis of portion (e) of FIG. 16 represents a drive signal of the actuator 50L. A vertical axis of portion (f) of FIG. 16 represents a drive signal of the actuator 50R. A vertical axis of portion (g) of FIG. 16 represents an output signal of the distance sensor 17 provided on the arm 12. A vertical axis of portion (h) of FIG. 16 represents an output signal of the distance sensor 17 provided on the arm 22. A vertical axis of portion (i) of FIG. 16 represents an output signal of the contact sensor 18 provided on the arm 12. A vertical axis of portion (j) of FIG. 16 represents an output signal of the contact sensor 18 provided on the arm 22. A vertical axis of portion (k) of FIG. 16 represents a set speed of the actuator 50L. A vertical axis of portion (l) of FIG. 16 represents a set speed of the actuator 50R.

When the two-wheeled motor vehicle 40 enters the parking device 1 while being displaced toward the left side, the tape switch 15 turns ON at a time point t10 (the output signal becomes Hi). The microcontroller 61 sets the movement speed of the actuator 50L to the low speed (Step S12 of FIG. 8). Moreover, in this example, the timing of starting the movement of the actuator 50L is delayed.

At time points t11 and t12, the phototube switches 26r and 26f successively turn ON, and the microcontroller 61 calculates the travel speed of the two-wheeled motor vehicle 40. At a time point t13, the actuator 50R starts moving. At a time point t14, the actuator 50L starts moving. When the distance between the arm 22 and the two-wheeled motor vehicle 40 falls below the threshold for the deceleration at a time point t15, the deceleration of the actuator 50R is started.

In this example, the two-wheeled motor vehicle 40 rolls rightward, and comes in contact with the arm 22 at a time point t16. The contact sensor 18 provided on the arm 22 turns ON (the output signal becomes Hi) through the contact. The microcontroller 61 immediately stops the movement of the actuator 50R in response to the output signal of the contact sensor. At a time point t17, the distance between the arm 12 and the two-wheeled motor vehicle 40 falls below the threshold for the deceleration, the deceleration of the actuator 50L is started, and the actuator 50L is stopped at a time point t18.

In such a manner, in the parking device 1 of the first preferred embodiment, even when the entry position and the posture of the two-wheeled motor vehicle 40 are disturbed, the arms 12 and 22 are moved at appropriate timings and speeds in accordance with the state of the two-wheeled motor vehicle 40, and the two-wheeled motor vehicle 40 is supported at the position at which the two-wheeled motor vehicle 40 stops.

In the above-described example, the parking device 1 includes the two arms 12 and 22, but may include only any one of the two arms 12 and 22. For example, in a mode in which the two-wheeled motor vehicle 40 is set to tilt only toward the left side when the two-wheeled motor vehicle 40 stops, the arm 22 may be omitted. Moreover, for example, in a mode in which the two-wheeled motor vehicle 40 is set to tilt only toward the right side when the two-wheeled motor vehicle 40 stops, the arm 12 may be omitted.

In the above-described example, as the arms that support the two-wheeled motor vehicle 40, the arms 12 and 22 each having a rod shape extending in the right-and-left direction are exemplified. The type of the arms can be suitably selected as long as the arms have a structure that is able to support the two-wheeled motor vehicle 40. For example, the arms that support the two-wheeled motor vehicle 40 may be robot arms.

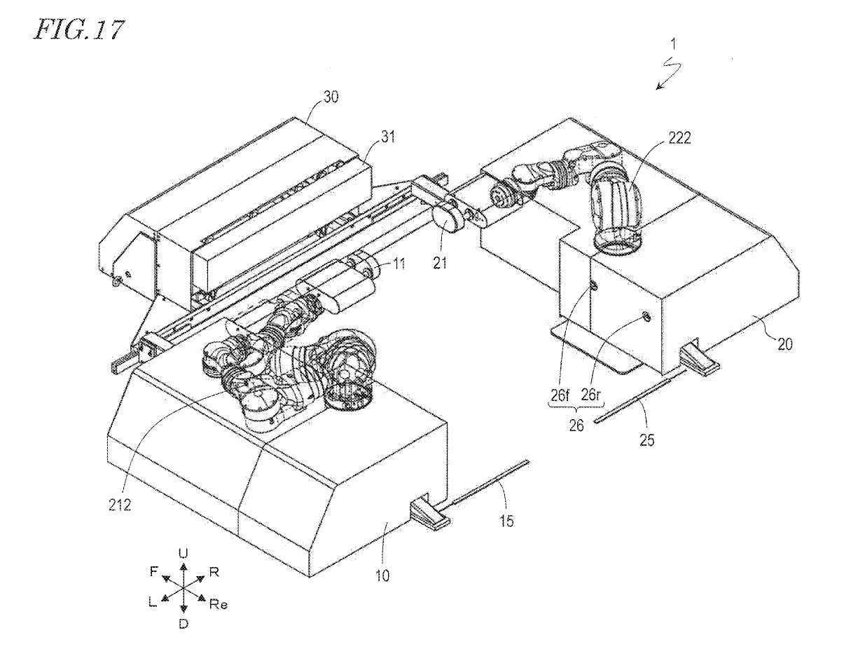

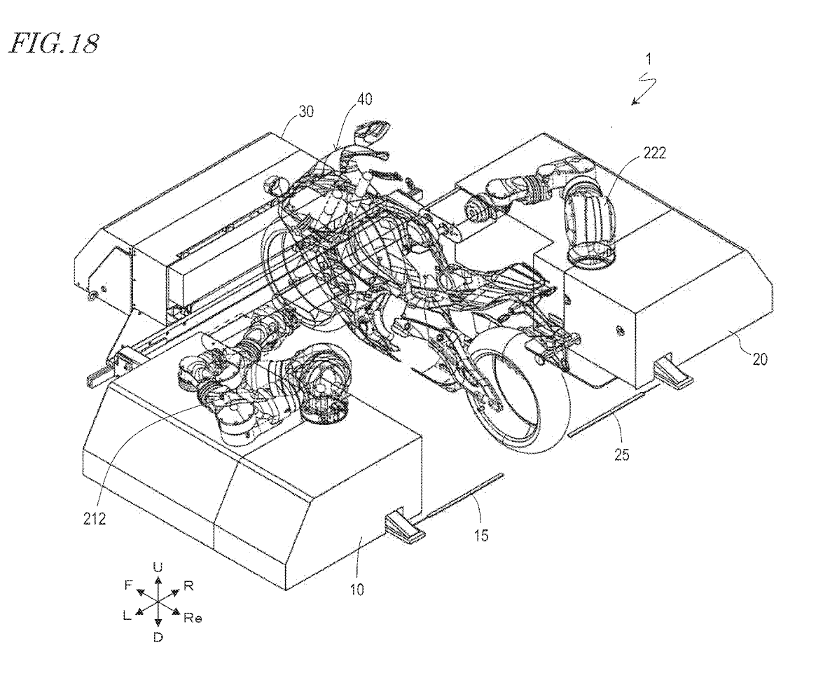

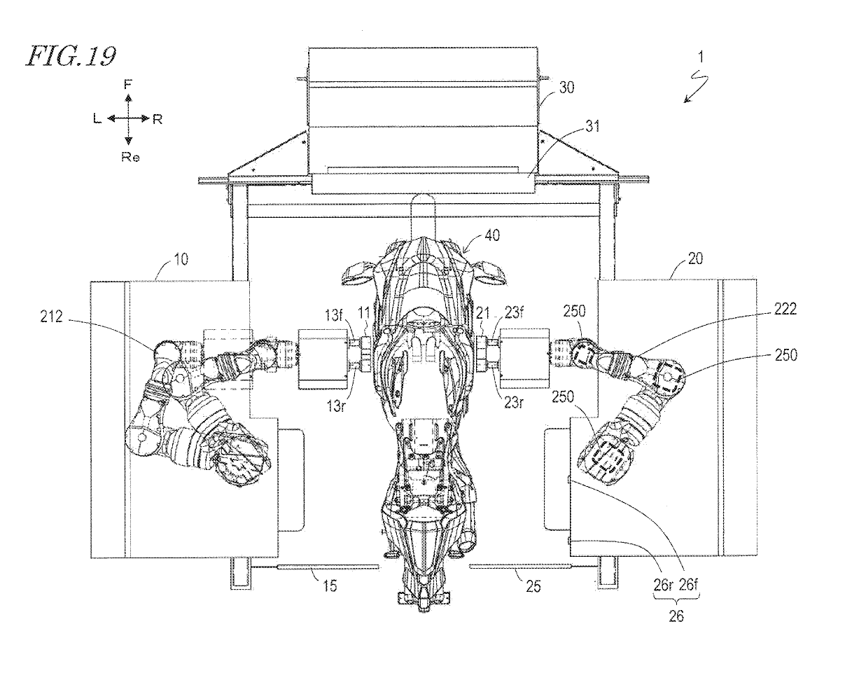

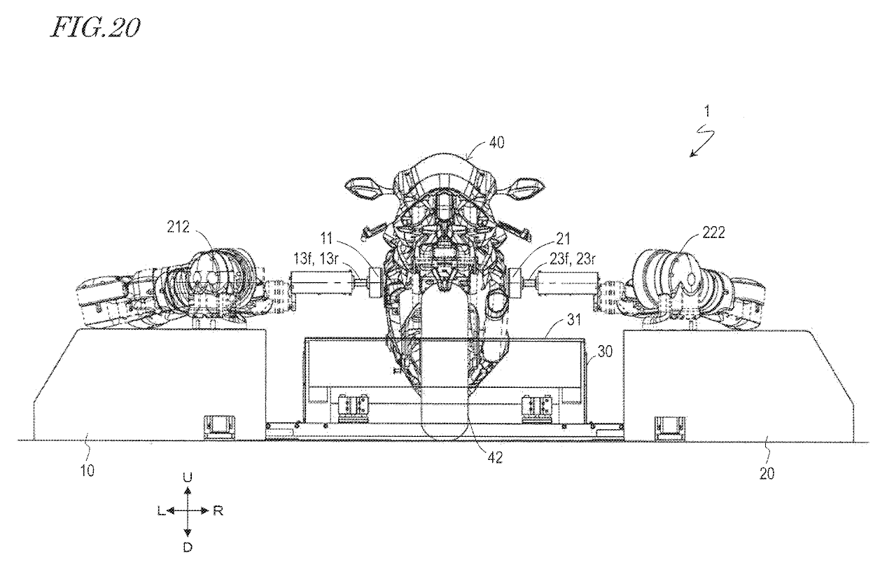

FIG. 17 to FIG. 20 are views for illustrating the parking device 1 including robot arms 212 and 222 in place of the arms 12 and 22. FIG. 17 is a perspective view for illustrating the parking device 1 in which the two-wheeled motor vehicle 40 is not shown. FIG. 18 is a perspective view for illustrating the parking device 1 in which the two-wheeled motor vehicle 40 is shown. FIG. 19 is a top view for illustrating the parking device 1. FIG. 20 is a rear view for illustrating the parking device 1.

The robot arm 212 is mounted to the left base 10. The robot arm 222 is mounted to the right base 20. In this example, each of the robot arms 212 and 222 includes a plurality of joints. As illustrated in FIG. 19, actuators 250 that bend and stretch the joints are provided in the joints of the robot arm 222. Although not illustrated in FIG. 19, similarly to the robot arm 222, actuators 250 that bend and stretch the joints are also provided in the joints of the robot arm 212. The type of the actuator 250 is suitably selected, and, for example, the actuator 250 includes an electric motor and a speed reducer. The actuators which are used to drive the robot arm are publicly known. Therefore, detailed description thereof is herein omitted.

The contact member 11 and the dampers 13f and 13r are provided in the robot arm 212. The contact member 21 and the dampers 23f and 23r are provided in the robot arm 222. The microcontroller 61 (FIG. 7) controls the actuators 250 to operate the robot arms 212 and 222, thus moving the contact members 11 and 21 to suitably-selected positions.

Through operations of the robot arms 212 and 222 similar to the operations described referring to FIG. 7 to FIG. 16, the two-wheeled motor vehicle 40, which has entered and stopped in the parking device 1, is appropriately supported by the robot arms 212 and 222. When the two-wheeled motor vehicle 40 is not parked in the parking device 1, the robot arm 212 is positioned on the left side, and the contact member 11 is spaced apart from the center of the parking device 1 in the right-and-left direction. Moreover, the robot arm 222 is positioned on the right side, and the contact member 21 is spaced apart from the center of the parking device 1 in the right-and-left direction. When the two-wheeled motor vehicle 40 enters the parking device 1, the microcontroller 61 controls the actuators 250 to operate the robot arms 212 and 222. The contact member 11 moves rightward, and the contact member 21 moves leftward through the operations of the robot arms 212 and 222. Before the contact members 11 and 21 come in contact with the two-wheeled motor vehicle 40, the robot arms 212 and 222 are stopped. The two-wheeled motor vehicle 40 having stopped in the parking device 1 tilts rightward or leftward, and thus comes in contact with and is supported by any one of the contact members 11 and 21. Regardless of whether the two-wheeled motor vehicle 40 tilts rightward or leftward after the stopping, the two-wheeled motor vehicle 40 is supported by the robot arm 212 or 222, and maintains the stop state in the upright posture without falling down. As a result, the two-wheeled motor vehicle 40 is parked without use of a mechanism that enables the two-wheeled motor vehicle 40 to stand by itself, such as a side stand, a center stand, or an outrigger.

Moreover, the robot arms 212 and 222 are able to provide three-dimensional movements, and thus positions in the up-and-down direction and positions in the front-and-rear direction of the contact members 11 and 21 are able to be adjusted. As a result, the contact members 11 and 21 are moved to more appropriate positions with respect to the two-wheeled motor vehicle 40 entering the parking device 1.

In the above-described example, the parking device 1 includes the two robot arms 212 and 222, but may include only any one of the two robot arms 212 and 222. For example, in a mode in which the two-wheeled motor vehicle 40 is set to tilt only toward the left side when the two-wheeled motor vehicle 40 stops, the robot arm 222 may be omitted. Moreover, for example, in a mode in which the two-wheeled motor vehicle 40 is set to tilt only toward the right side when the two-wheeled motor vehicle 40 stops, the robot arm 212 may be omitted.

Second Preferred Embodiment

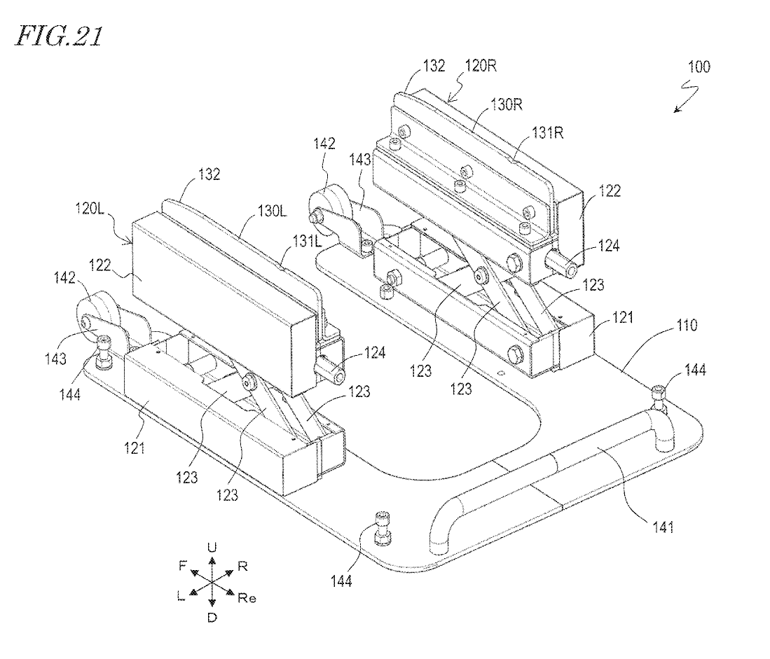

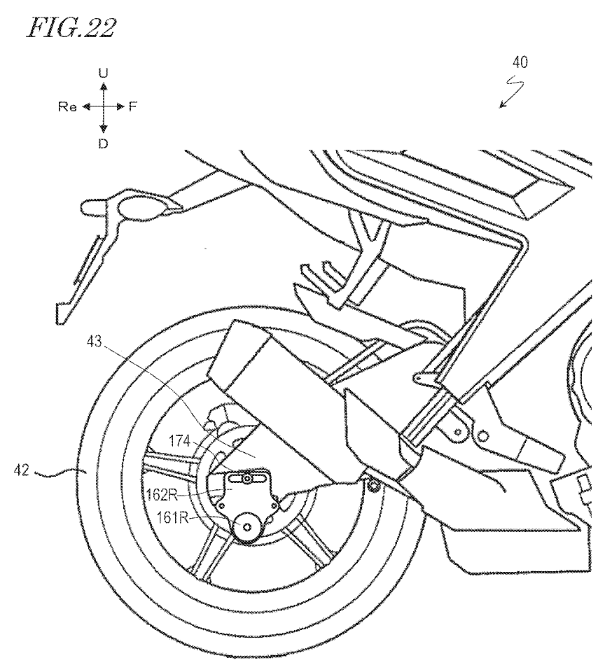

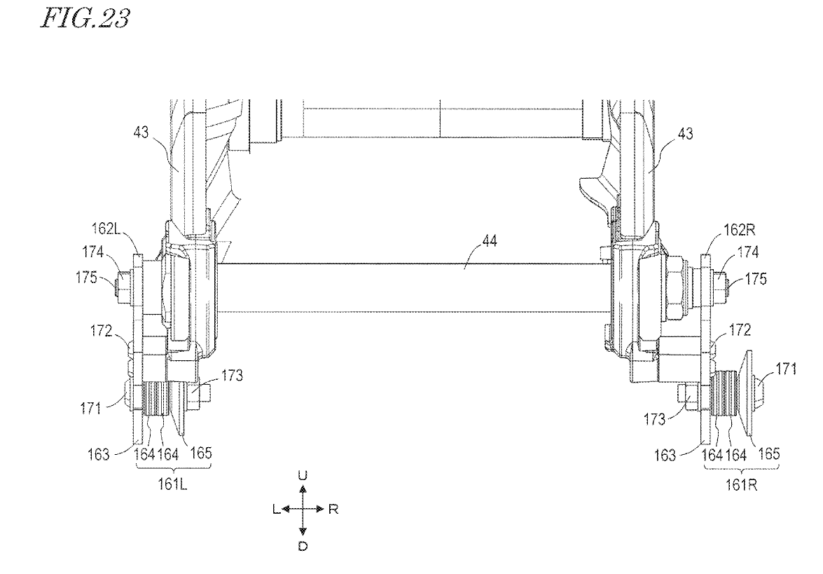

Next, description is provided of a start assist device that assists starting a straddled vehicle. FIG. 21 is a perspective view for illustrating a start assist device 100 according to a second preferred embodiment of the present invention. FIG. 22 is a side view for illustrating a rear portion of the two-wheeled motor vehicle 40. FIG. 23 is a view for illustrating spools 161L and 161R provided on the two-wheeled motor vehicle 40.

The start assist device 100 of the second preferred embodiment supports the two-wheeled motor vehicle 40 in the upright posture, thus parking the two-wheeled motor vehicle 40. Moreover, when the two-wheeled motor vehicle 40 starts, the two-wheeled motor vehicle 40 is started while the two-wheeled motor vehicle 40 is maintained in a state of being supported in the upright posture by the start assist device 100.

The start assist device 100 includes a base 110, a jack 120L, a jack 120R, a rail 130L, and a rail 130R. The jack 120L is provided on the left side of the base 110. The jack 120R is provided on the right side of the base 110.

Each of the jacks 120L and 120R includes a lower stand 121, an upper stand 122, and a plurality of arms 123. The lower stand 121, the upper stand 122, and the plurality of arms 123 define an extension and retraction mechanism. The jacks 120L and 120R may have a pantograph structure. The upper stand 122 is moved up and down through insertion of a handle (not shown) into a sleeve 124 and rotation of the sleeve 124. A type of the jack is suitably selected, and a mechanical jack, a liquid operation jack, or the like may be used. The structure that moves up and down the jack is publicly known, and hence detailed description thereof is herein omitted.

The jack 120L supports the rail 130L. The jack 120R supports the rail 130R. In this example, the rail 130L is mounted to the upper stand 122 of the jack 120L. The rail 130R is mounted to the upper stand 122 of the jack 120R. The rails 130L and 130R extend in the front-and-rear direction. A lengthwise direction of the rail 130L and a lengthwise direction of the rail 130R are parallel or substantially parallel to one another. A height of the rail 130L is adjusted by moving up and down the upper stand 122 of the jack 120L. A height of the rail 130R is adjusted by moving up and down the upper stand 122 of the jack 120R.

Forks 143 are mounted on a left front side and a right front side of the base 110 of the start assist device 100, respectively. The forks 143 each support a wheel 142. A grip 141 is mounted to a rear portion of the base 110. A user is able to move the start assist device 100 by holding the grip 141 by hand and bringing the wheels 142 in contact with the ground. Level adjusting screws 144 are provided at four corners of the base 110. The user is able to adjust the angle of the base 110 by operating the level adjusting screws 144.

FIG. 23 is a view for illustrating a portion of the rear portion of the two-wheeled motor vehicle 40. Referring to FIG. 22 and FIG. 23, the two-wheeled motor vehicle 40 includes swing arms 43. An axle 44 that supports a rear wheel 42 is mounted to the swing arms 43. The axle 44 includes thread portions 175 at both end portions. Brackets 162L and 162R are mounted to the thread portions 175 through use of nuts 174. The brackets 162L and 162R are also mounted to the swing arms 43 through use of bolts 172.

The spool 161L is mounted to a lower portion of the bracket 162L through use of a bolt 171 and a nut 173, for example. The spool 161R is mounted to a lower portion of the bracket 162R through use of the bolt 171 and the nut 173, for example. The spool is also referred to as an anchor. In this example, each of the spools 161L and 161R includes at least one ball bearing 164 and a flange 165. The bolt 171 passes through the ball bearing 164 and the flange 165. The ball bearing 164 is rotatable about the bolt 171. The flange 165 may also be rotatable about the bolt 171. In this example, a bottom portion 163 of each of the brackets 162L and 162R define a flange.

When the two-wheeled motor vehicle 40 is to be parked, the rear wheel 42 of the two-wheeled motor vehicle 40 is caused to enter from the front side of the start assist device 100. The rear wheel 42 passes between the jack 120L and the jack 120R, and moves to the rear side of the start assist device 100. At this time, the spool 161L rides on the rail 130L, and the spool 161R rides on the rail 130R. The spools 161L and 161R move along the lengthwise directions of the rails 130L and 130R. At this time, friction resistance between the spools 161L and 161R and the rails 130L and 130R is reduced through rotation of the ball bearings 164 of the spools 161L and 161R. The bottom portions 163 and the flanges 165 of the brackets 162L and 162R prevent derailment of the spools 161L and 161R from the rails 130L and 130R.

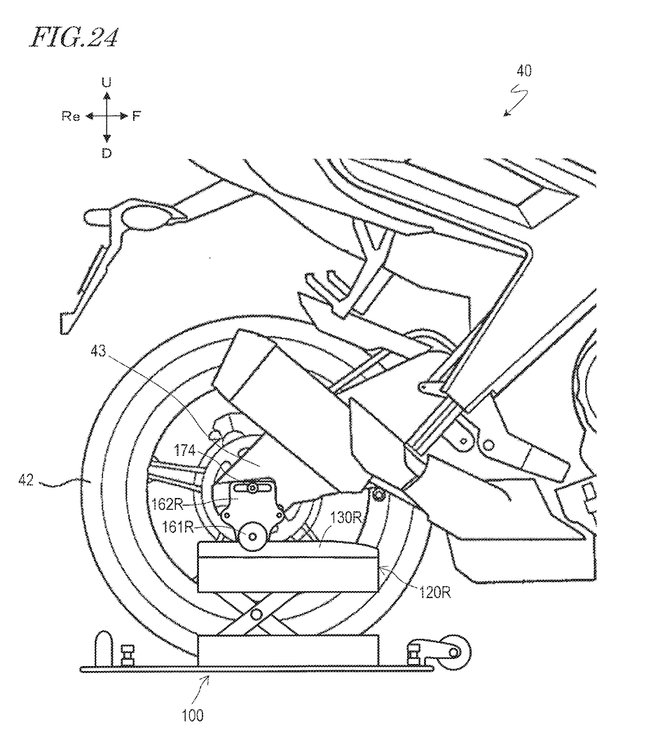

The rail 130L includes, in a rear portion thereof, a recess 131L to which the spool 161L is fitted. The rail 130R includes, in a rear portion thereof, a recess 131R to which the spool 161R is fitted. The two-wheeled motor vehicle 40 is stopped at a position at which the spools 161L and 161R are fitted to the recesses 131L and 131R, respectively. Displacement of the position of the two-wheeled motor vehicle 40 is significantly reduced or prevented during parking by fitting the spools 161L and 161R to the recesses 131L and 131R. FIG. 24 is a view for illustrating the two-wheeled motor vehicle 40 parked in a state in which the spools 161L and 161R are fitted to the recesses 131L and 131R. The start assist device 100 parks the two-wheeled motor vehicle 40 in the upright posture through support of the spools 161L and 161R by the rails 130L and 130R.

The start assist device 100 of the second preferred embodiment includes the jacks 120L and 120R which enable adjustment of the heights of the rails 130L and 130R independently of one another. Even when the ground on which the start assist device 100 is installed is inclined, the heights of the rails 130L and 130R are able to be matched to one another through the independent adjustment of the heights of the rails 130L and 130R. In other words, heights of the spools 161L and 161R resting on the rails 130L and 130R are matched to one another. As a result, the two-wheeled motor vehicle 40 is parked in the upright posture.

The rails 130L and 130R may be mounted to the upper stands 122 through intermediation of dampers. Even when entry positions of the spools 161L and 161R are displaced, the rails 130L and 130R are caused to follow positions of the spools 161L and 161R through extension and retraction of the dampers.

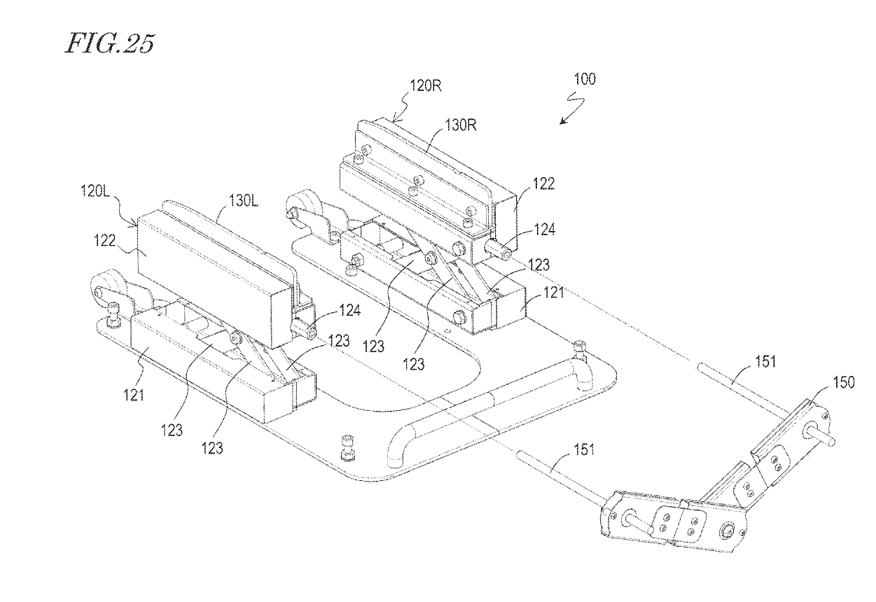

When maintenance of the two-wheeled motor vehicle 40 is carried out, the rear wheel 42 is lifted from the ground by operating the jacks 120L and 120R to raise the positions of the rails 130L and 130R. At this time, for example, when a jig 150 as illustrated in FIG. 25 is used, the jacks 120L and 120R are able to be simultaneously be moved up and down by the same length. The jig 150 includes, for example, a ratchet. A handle is mounted to the jig 150, and two rods 151 of the jig 150 are inserted into the sleeves 124 of the jacks 120L and 120R, respectively. The jacks 120L and 120R are able to simultaneously be moved up and down by the same length by operating the handle to rotate the sleeves 124.

Moreover, through adjustment of the heights of the rails 130L and 130R, the two-wheeled motor vehicle 40 is parked in the state in which the rear wheel 42 is in contact with the ground without lifting the rear wheel 42. In this case, when the two-wheeled motor vehicle 40 starts, the two-wheeled motor vehicle 40 is started while the two-wheeled motor vehicle 40 is maintained in a state of being supported in the upright posture by the start assist device 100.

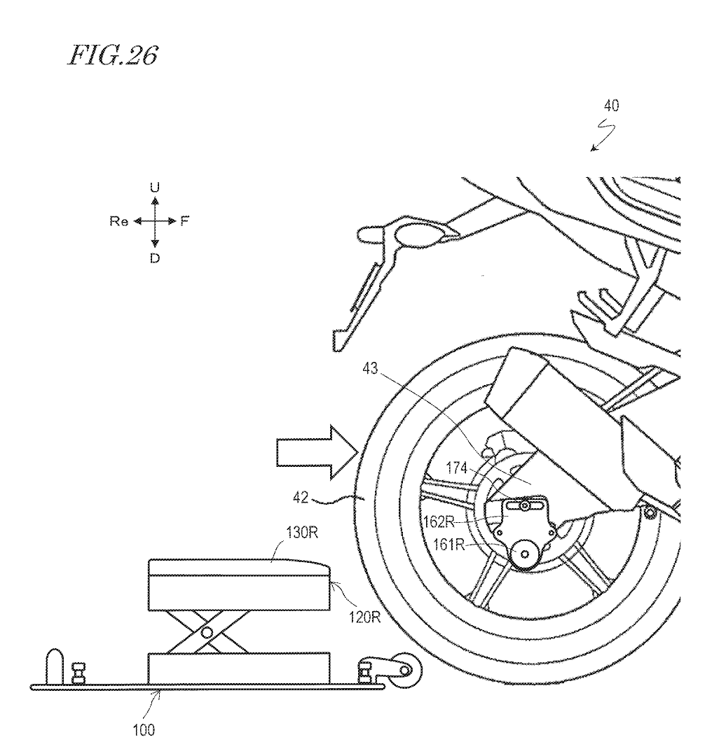

When the rear wheel 42 of the two-wheeled motor vehicle 40 held in contact with the ground rotates upon the start of the two-wheeled motor vehicle 40, the spools 161L and 161R move along the lengthwise directions of the rails 130L and 130R. At this time, the friction resistance between the spools 161L and 161R and the rails 130L and 130R is reduced through rotation of the ball bearings 164 of the spools 161L and 161R. FIG. 26 is a view for illustrating the two-wheeled motor vehicle 40 starting and moving forward from the start assist device 100.

Moreover, as illustrated in FIG. 21, in the start assist device 100 of the second preferred embodiment, a front portion 132 of each of the rails 130L and 130R has a tapered shape. Due to the tapered shape of each of the rails 130L and 130R, interference between the spools 161L and 161R and the front portions 132 of the rails 130L and 130R is prevented when the two-wheeled motor vehicle 40 is parked and started. In the second preferred embodiment, a gently round shape (gentle arc shape) is also included in the meaning of the tapered shape. Moreover, a shape of a combination of a flat shape and a taper shape is also included in the meaning of the tapered shape.

In the above description, the exemplary preferred embodiments of the present invention have been described.

As described above, the parking device 1 that parks the straddled vehicle 40 according to a preferred embodiment of the present invention includes the arms 12 and 22, the actuators 50L and 50R, and the controller 60. The arms 12 and 22 support the straddled vehicle 40. The actuators 50L and 50R move the positions of the arms 12 and 22. The controller 60 is configured or programmed to control the operations of the actuators 50L and 50R. The controller 60 controls the actuators 50L and 50R to bring the arms 12 and 22 adjacent to the straddled vehicle 40 in accordance with the entry of the straddled vehicle 40 into the parking device 1.

The arms 12 and 22 that support the straddled vehicle 40 are brought adjacent to the straddled vehicle 40 in accordance with the entry of the straddled vehicle 40 into the parking device 1. The straddled vehicle 40 is supported by the arms 12 and 22, and maintains the stop state in the upright posture without falling down. Therefore, the straddled vehicle 40 is able to be parked without use of a mechanism that enables the straddled vehicle 40 to stand by itself, such as a side stand, a center stand, or an outrigger.

According to a preferred embodiment of the present invention, the parking device 1 includes the speed sensor 26 that detects the travel speed of the straddled vehicle 40 entering the parking device 1. The controller 60 is configured or programmed to change the timings of starting movements of the arms 12 and 22 in accordance with the detected travel speed of the straddled vehicle 40.

The timings of starting the movements of the arms 12 and 22 are changed in accordance with the travel speed of the straddled vehicle 40. Therefore, the contact between the straddled vehicle 40, which travels in the parking device 1, and the arms 12 and 22 is prevented, and the arms 12 and 22 are brought sufficiently adjacent to the straddled vehicle 40 at the timing at which the straddled vehicle 40 stops.

According to a preferred embodiment of the present invention, when the detected speed of the straddled vehicle 40 is lower than a predetermined speed, the controller 60 delays the timings of starting the movements of the arms 12 and 22 compared with the case in which the detected speed is equal to or higher than the predetermined speed.

Therefore, the contact between the straddled vehicle 40, which travels in the parking device 1, and the arms 12 and 22 is prevented, and the arms 12 and 22 are brought sufficiently adjacent to the straddled vehicle 40 at the timing at which the straddled vehicle 40 stops.

According to a preferred embodiment of the present invention, the parking device 1 includes the speed sensor 26 that detects the travel speed of the straddled vehicle 40 entering the parking device 1. The controller 60 is configured or programmed to change the movement speeds of the arms 12 and 22 in accordance with the detected travel speed of the straddled vehicle 40.

The movement speeds of the arms 12 and 22 are changed in accordance with the travel speed of the straddled vehicle 40. Therefore, the contact between the straddled vehicle 40, which travels in the parking device 1, and the arms 12 and 22 is prevented, and the arms 12 and 22 are brought sufficiently adjacent to the straddled vehicle 40 at the timing at which the straddled vehicle 40 stops.

According to a preferred embodiment of the present invention, when the detected speed of the straddled vehicle 40 is lower than the predetermined speed, the controller 60 reduces the movement speeds of the arms 12 and 22 compared with the case in which the detected speed is equal to or higher than the predetermined speed.

Therefore, the contact between the straddled vehicle 40 traveling in the parking device 1 and the arms 12 and 22 is prevented, and the arms 12 and 22 are brought sufficiently adjacent to the straddled vehicle 40 at the timing at which the straddled vehicle 40 stops.

According to a preferred embodiment of the present invention, the parking device 1 includes the contact sensors 18 that detect whether or not the arms 12 and 22 are in contact with the straddled vehicle 40. When the contact of the arms 12 and 22 with the straddled vehicle 40 is detected, the controller 60 stops the movements of the arms 12 and 22.

When the arms 12 and 22 continue to move after the arms 12 and 22 come in contact with the straddled vehicle 40, the posture of the straddled vehicle 40 may be disturbed. When the arms 12 and 22 come in contact with the straddled vehicle 40, the disturbance of the posture of the straddled vehicle 40 is significantly reduced or prevented stopping the movements of the arms 12 and 22.

According to a preferred embodiment of the present invention, the parking device 1 includes the distance sensors 17 that detect the distance between the arm 12 and the straddled vehicle 40 and the distance between the arm 22 and the straddled vehicle 40. When the distance between the arm 12 and the straddled vehicle 40 and the distance between the arm 22 and the straddled vehicle 40 fall below the predetermined value, the controller 60 reduces the movement speeds of the arms 12 and 22.

Therefore, the contact force between the straddled vehicle 40, which travels in the parking device 1, and the arms 12 and 22 is reduced.

According to a preferred embodiment of the present invention, the actuator 50L moves the arm 12, and the actuator 50R moves the arm 22. The controller 60 is configured or programmed to control the actuator 50L to bring the arm 12 adjacent to the straddled vehicle 40 from the left side of the straddled vehicle 40, and control the actuator 50R to bring the arm 22 adjacent to the straddled vehicle 40 from the right side of the straddled vehicle 40.

The arms 12 and 22 are brought adjacent to the straddled vehicle 40 from both the left side and the right side of the straddled vehicle 40 in accordance with the entry of the straddled vehicle 40 into the parking device 1. Regardless of whether the straddled vehicle 40 tilts rightward or leftward after stopping, the straddled vehicle 40 is supported by the arm 12 or 22, and maintains the stop state in the upright posture without falling down. Therefore, the straddled vehicle 40 is parked without use of a mechanism that enables the straddled vehicle 40 to stand by itself, such as a side stand, a center stand, or an outrigger.

According to a preferred embodiment of the present invention, the parking device 1 includes the position sensors 15 and 25 that detect the entry position of the straddled vehicle 40 into the parking device 1. The controller 60 is configured or programmed to set at least one of the movement speed and the timing of starting movement for each of the respective arms 12 and 22 in accordance with the detected entry position of the straddled vehicle 40.

One of the movement speed and the timing of starting movement for each of the respective arms 12 and 22 is set in accordance with the entry position of the straddled vehicle 40. Therefore, the contact between the straddled vehicle 40, which travels in the parking device 1, and the arms 12 and 22 is prevented, and the arms 12 and 22 can be brought sufficiently adjacent to the straddled vehicle 40 at the timing at which the straddled vehicle 40 stops.

According to a preferred embodiment of the present invention, when the detected entry position of the straddled vehicle 40 is closer to the left side of the parking device 1 than the right side of the parking device 1, the controller 60 performs one of setting of the movement speed of the arm 12 to a speed lower than the movement speed of the arm 22 and delaying of the timing of starting the movement of the arm 12 compared with the timing of starting the movement of the arm 22.

Therefore, the contact between the straddled vehicle 40, which travels in the parking device 1, and the arm 12 is prevented, and the arms 12 and 22 are brought sufficiently adjacent to the straddled vehicle 40 at the timing at which the straddled vehicle 40 stops.

According to a preferred embodiment of the present invention, the controller 60 is configured or programmed to calculate the distance between the arm 12 and the arm 22 based on the operation amounts of the actuator 50L and the actuator 50R. The controller 60 is configured or programmed to stop the movements of the arm 12 and the arm 22 when the distance between the arm 12 and the arm 22 falls below the predetermined value.

The controller 60 is configured or programmed to stop the movements of the arms 12 and 22 when the distance between the arm 12 and the arm 22 falls below the predetermined value. The contact between the straddled vehicle 40, which travels in the parking device 1, and the arms 12 and 22 is prevented by preventing the gap between the arm 12 and the arm 22 from becoming excessively small.

The start assist device 100 according to a preferred embodiment of the present invention includes the rail 130L, the rail 130R, the jack 120L, and the jack 120R. The rail 130L carries the spool 161L of the straddled vehicle 40. The rail 130R carries the spool 161R of the straddled vehicle 40. The jack 120L supports the rail 130L. The jack 120R supports the rail 130R. The jack 120L enables adjustment of the height of the rail 130L. The jack 120R enables adjustment of the height of the rail 130R.

The spools 161L and 161R are mounted, for example, to the left side and the right side of the rear wheel 42 of the straddled vehicle 40. The start assist device 100 includes the jacks 120L and 120R which enable adjustment of the heights of the rails 130L and 130R independently of one another. Even when the ground on which the start assist device 100 is installed is inclined, the heights of the rails 130L and 130R are able to be matched to one another through the independent adjustment of the heights of the rails 130L and 130R. In other words, heights of the spools 161L and 161R resting on the rails 130L and 130R are matched to one another. Therefore, the straddled vehicle 40 is parked in the upright posture.

Moreover, through adjustment of the heights of the rails 130L and 130R, the straddled vehicle 40 is able to be parked in the state in which the rear wheel 42 is in contact with the ground without lifting the rear wheel 42. When the straddled vehicle 40 starts, the straddled vehicle 40 is started while the straddled vehicle 40 is maintained in a state of being supported in the upright posture by the start assist device 100.

When maintenance of the straddled vehicle 40 is performed, the rear wheel 42 of the straddled vehicle 40 is lifted from the ground by raising the positions of the rails 130L and 130R.

According to a preferred embodiment of the present invention, the lengthwise direction of the rail 130L and the lengthwise direction of the rail 130R are parallel or substantially parallel to one another. The straddled vehicle 40 is movable along the lengthwise directions of the rails 130L and 130R.

When the rear wheel 42 of the straddled vehicle 40 held in contact with the ground rotates upon the start of the straddled vehicle 40, the spools 161L and 161R move along the lengthwise directions of the rails 130L and 130R. Therefore, the straddled vehicle 40 is started while the straddled vehicle 40 is maintained in a state of being supported by the start assist device 100 in the upright posture.

According to a preferred embodiment of the present invention, the rail 130L includes the recess 131L to which the spool 161L is fitted. The rail 130R includes the recess 131R to which the spool 161R is fitted.

The displacement of the position of the straddled vehicle 40 is significantly reduced or prevented during parking with the structure in which the rails 130L and 130R include the recesses 131L and 131R to which the spools 161L and 161R are fitted respectively.

According to a preferred embodiment of the present invention, at least a portion of the rail 130L has the tapered shape, and at least a portion of the rail 130R has the tapered shape.

Due to the tapered shape of each of the rails 130L and 130R, interference between the spools 161L and 161R and the rails 130L and 130R is prevented when the straddled vehicle 40 is parked and started.

In the above description, preferred embodiments of the present invention have been described. The description of the preferred embodiments exemplifies the present invention, and does not limit the present invention. Moreover, a preferred embodiment formed by appropriately combining the respective components described in the above-described preferred embodiments is conceivable. A change, a replacement, an addition, and an omission can be made to any preferred embodiment of the present invention within the scope of claims or a scope that is equivalent thereto.

Preferred embodiments of the present invention are particularly useful in a technical field relating to the parking of the straddled vehicle.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A parking device for use to park a straddled vehicle, the parking device comprising:
an arm that supports the vehicle;
an actuator that moves a position of the arm; and
a controller configured or programmed to control an operation of the actuator to bring the arm adjacent to the vehicle in accordance with entry of the vehicle into the parking device.

2. The parking device according to claim 1, further comprising a speed sensor that detects a travel speed of the vehicle entering the parking device; wherein
the controller is configured or programmed to change a timing of starting a movement of the arm in accordance with the detected travel speed of the vehicle.

3. The parking device according to claim 2, wherein, when the detected speed of the vehicle is lower than a predetermined speed, the controller is configured or programmed to delay the timing of starting the movement of the arm compared with a case in which the detected speed is equal to or higher than the predetermined speed.

4. The parking device according to claim 1, further comprising a speed sensor that detects a travel speed of the vehicle entering the parking device; wherein
the controller is configured or programmed to change a movement speed of the arm in accordance with the detected travel speed of the vehicle.

5. The parking device according to claim 4, wherein, when the detected speed of the vehicle is lower than a predetermined speed, the controller reduces the movement speed of the arm compared with the case in which the detected speed is equal to or higher than the predetermined speed.

6. The parking device according to claim 1, further comprising a contact sensor that detects whether or not the arm is in contact with the vehicle; wherein
when the contact of the arm with the vehicle is detected, the controller is configured or programmed to stop the movement of the arm.

7. The parking device according to claim 1, further comprising a distance sensor that detects a distance between the arm and the vehicle; wherein
when the distance between the arm and the vehicle falls below a predetermined value, the controller is configured or programmed to reduce the movement speed of the arm.

8. The parking device according to claim 1, wherein
the arm includes a first arm and a second arm;
the actuator includes a first actuator that moves the first arm, and a second actuator that moves the second arm; and
the controller is configured or programmed to:
control the first actuator to bring the first arm adjacent to the vehicle from a left side of the vehicle; and
control the second actuator to bring the second arm adjacent to the vehicle from a right side of the vehicle.

9. The parking device according to claim 8, further comprising a position sensor detects an entry position of the vehicle into the parking device; wherein
the controller is configured or programmed to set at least one of a movement speed and a timing of starting movement for each of the first arm and the second arm in accordance with the detected entry position of the vehicle.

10. The parking device according to claim 9, wherein, when the detected entry position of the vehicle is closer to a left side of the parking device than a right side of the parking device, the controller is configured or programmed to perform one of:
setting the movement speed of the first arm to a speed lower than the movement speed of the second arm; and
delaying the timing of starting the movement of the first arm compared with the timing of starting the movement of the second arm.

11. The parking device according to claim 8, wherein the controller is configured or programmed to:
calculate a distance between the first arm and the second arm based on operation amounts of the first actuator and the second actuator; and
stop the movements of the first arm and the second arm when the distance between the first arm and the second arm falls below a predetermined value.

12. A start assist device comprising:
a first rail that carries a first spool of a straddled vehicle;
a second rail that carries a second spool of the straddled vehicle;
a first jack that supports the first rail; and
a second jack that supports the second rail; wherein
the first jack adjusts a height of the first rail, and the second jack adjusts a height of the second rail.

13. The start assist device according to claim 12, wherein
a lengthwise direction of the first rail and a lengthwise direction of the second rail are parallel or substantially parallel to one another; and
the straddled vehicle is movable along the lengthwise directions of the first rail and the second rail.

14. The start assist device according to claim 12, wherein
the first rail includes a recess to which the first spool is fitted; and
the second rail includes a recess to which the second spool is fitted.

15. The start assist device according to claim 12, wherein at least a portion of the first rail has a tapered shape; and
at least a portion of the second rail has a tapered shape.
